(19) United States
(12) Patent Application Publication
(10) Pub. No.: US 2024/0079151 A1
(43) Pub. Date: Mar. 7, 2024

(54) PLASMA INJECTION AND CONFINEMENT SYSTEMS AND METHODS

(71) Applicant: FUSE ENERGY TECHNOLOGIES CORP., New York, NY (US)

(72) Inventors: Raymond GOLINGO, Napierville (CA); Jean-Christoph BTAICHE, Napierville (CA); Paul HARRIS, Montreal (CA); Ayan CHOUDHURY, Napierville (CA); Zahra SEIFOLLAHI MOGHADAM, Napierville (CA); Pierre TOCHON, Napierville (CA)

(73) Assignee: FUSE ENERGY TECHNOLOGIES CORP., New York, NY (US)

(21) Appl. No.: 18/256,760

(22) PCT Filed: Dec. 10, 2021
(86) PCT No.: PCT/US2021/062830

§ 371 Date: Jun. 9, 2023

Related U.S. Application Data
(60) Provisional application No. 63/123,892, filed on Dec. 10, 2020.

(51) Int. Cl. G21B 1/05; H05H 1/54

(52) U.S. Cl. CPC G21B 1/05; H05H 1/54; G21B 1/21

(57) ABSTRACT

Plasma processing systems and methods for fusion power applications are disclosed. The system can include a plasma confinement device including a reaction chamber; a plasma formation and injection device configured to form a source plasma outside the reaction chamber and inject the source plasma inside the reaction chamber; and a power supply configured to supply power to the plasma confinement device to apply a voltage across the reaction chamber to compress the source plasma into a Z-pinch plasma capable of sustaining fusion reactions. The plasma confinement device can include an inner electrode surrounded by an outer electrode to define therebetween an acceleration region of the reaction chamber. The outer electrode can extend beyond the inner electrode to define an assembly region of the reaction chamber. The source plasma can be injected in the acceleration region and flowed into the assembly region to be compressed into the Z-pinch plasma.

### CROSS-REFERENCE TO RELATED PATENT APPLICATION(S)

The present application claims priority to U.S. Provisional Patent Application No. 63/123,892 filed on Dec. 10, 2020, the disclosure of which is incorporated herein by reference in its entirety.

### TECHNICAL FIELD

The technical field generally relates to techniques to generate and confine plasmas, and more particularly, to the use of such techniques to produce nuclear fusion energy.

### BACKGROUND

Nuclear fusion energy is energy produced by a nuclear fusion process in which two or more lighter atomic nuclei are joined to form a heavier nucleus whose mass is less than the sum of the masses of the lighter nuclei. The difference in mass is released as energy, which can be harnessed to produce electricity. Fusion reactors are devices whose function is to harness fusion energy. One type of fusion reactors relies on magnetic plasma confinement. Such fusion reactors aim to confine high-temperature plasmas to sufficiently high-density with prolonged stability. Non-limiting examples of magnetic plasma confinement approaches include Z-pinch-configurations, magnetic mirror configurations, and toroidal configurations, for example, the tokamak and the stellarator. In Z-pinch configurations, a plasma column with an axial current flowing through it generates an azimuthal magnetic field that radially compresses the plasma, resulting in an increase of the fusion reaction rate. Z-pinch reactors are attractive due to their simple geometry, absence of magnetic field coils for plasma confinement and stabilization, inherent compactness, and relatively low cost. Conventional Z-pinch reactors suffer from instabilities that limit plasma lifetimes. Recent research has found that stabilization of the plasma with a sheared flow can help reduce these instabilities, opening up the possibility of producing and sustaining stable Z-pinches over longer timescales. However, despite these advances, challenges remain in the field of Z-pinch-based fusion devices.

### SUMMARY

The present description generally relates to plasma injection and confinement techniques for use in fusion power generation.

In accordance with an aspect, there is provided a plasma processing system, including:
a plasma confinement device including a reaction chamber;
a plasma formation and injection device configured to form a source plasma outside the reaction chamber and inject the source plasma inside the reaction chamber; and
a main power supply configured to supply power to the plasma confinement device to apply a voltage across the reaction chamber configured to compress the source plasma into a Z-pinch plasma.

In some embodiments, the plasma confinement device includes an inner electrode and an outer electrode surrounding the inner electrode to define an acceleration region therebetween, the outer electrode extending beyond the inner electrode along a Z-pinch axis to define an assembly region adjacent the acceleration region, the acceleration region and the assembly region forming the reaction chamber; the plasma formation and injection device is configured to inject the source plasma into the acceleration region; and the main power supply is configured to apply the voltage between the inner electrode and the outer electrode to cause the source plasma to flow along the acceleration region and into the assembly region and to be compressed into the Z-pinch plasma along the Z-pinch axis in the assembly region.

In some embodiments, the outer electrode surrounds the inner electrode coaxially with respect to the Z-pinch axis. In some embodiments, the inner electrode and the outer electrode each have a circular cross-section transverse to the Z-pinch axis. In some embodiments, the acceleration region has a length ranging from about 25 cm to about 1.5 m, and wherein the assembly region has a length ranging from about 25 cm to about 3 m.

In some embodiments, the plasma formation and injection device includes a plasma generator configured to generate the source plasma; and a plasma injector configured to inject the source plasma into the acceleration region. In some embodiments, the plasma injector includes a plasma injection port formed through the inner electrode, through the outer electrode, or through a rear end wall of the plasma confinement device. In some embodiments, the plasma generator includes a plurality of plasma generators, each plasma generator being configured to generate a respective portion of the source plasma, and the plasma injector includes a plurality of plasma injectors, each plasma injector corresponding to a respective one of the plasma generators and being configured to inject the respective portion of the source plasma into the acceleration region. In some embodiments, the plasma generator includes an inner electrode and an outer electrode surrounding the inner electrode to define a plasma formation region therebetween, the outer electrode extending beyond the inner electrode along a plasma formation axis to enclose a plasma transport channel extending from the plasma formation region to the plasma injector along the plasma formation axis.

In some embodiments, the plasma formation and injection device includes at least one plasma generator configured to generate the initial plasma and at least one plasma injector configured to inject the initial plasma inside the reaction chamber, wherein the number of the at least one plasma generator is either equal to or different from the number of the at least one plasma injector.

In some embodiments, the plasma formation and injection device includes a process gas supply unit configured to supply a process gas into the plasma formation region; and a plasma formation power supply configured to apply a voltage between the inner electrode and the outer electrode of the plasma generator to energize the process gas into the source plasma and cause the source plasma to flow along the plasma formation region and through the plasma transport channel to reach the plasma injector for injection of the source plasma into the acceleration region. In some embodiments, the process gas includes deuterium, tritium, hydrogen, or helium, or any combination thereof.

In some embodiments, the source plasma is configured to flow along a first flow direction in the plasma transport channel and along a second flow direction in the acceleration region, the first flow direction and the second flow direction making an acute angle with respect to each other.

In some embodiments, the plasma formation and injection device is configured to start injecting the source plasma inside the reaction chamber before the main power supply is configured to start applying the voltage across the reaction chamber. In some embodiments, the plasma formation and injection device is configured to start injecting the source plasma inside the reaction chamber at the same time as or after the main power supply is configured to start applying the voltage across the reaction chamber. In some embodiments, the plasma formation and injection device is configured to continue injecting the source plasma inside the reaction chamber and the main power supply is configured to continue applying the voltage across the reaction chamber to feed and sustain the Z-pinch plasma.

In some embodiments, the main power supply is a pulsed-DC power supply including a capacitor bank and a switch. In some embodiments, the main power supply is configured to apply the voltage in a voltage range from about 1 kV to about 40 kV.

In some embodiments, the Z-pinch plasma includes a sheared axial flow.

In some embodiments, the Z-pinch plasma is configured to undergo nuclear fusion reactions in response to compression of the Z-pinch plasma. In some embodiments, the nuclear fusion reactions include neutronic fusion reactions.

In some embodiments, the plasma processing system further includes a vacuum system including a vacuum chamber enclosing the reaction chamber.

In some embodiments, the plasma processing system further includes a control and processing device operatively coupled at least to the plasma formation and injection device, and the main power supplying, the computer device including a processor and a non-transitory computer readable storage medium having stored thereon computer readable instructions that, when executed by the processor, cause the processor to perform operations, the operations including controlling the plasma formation and injection device to form the source plasma and to inject the source plasma inside the reaction chamber; controlling the main power supply to supply power to the plasma confinement device to apply the voltage across the reaction chamber configured to compress the source plasma into a Z-pinch plasma.

In accordance with another, there is provided a plasma processing method, including:
forming a source plasma outside a reaction chamber of a plasma confinement device;
introducing the source plasma inside the reaction chamber; and
supplying power to the plasma confinement device to apply a voltage across the reaction chamber configured to compress the source plasma into a Z-pinch plasma.

In some embodiments, introducing the source plasma inside the reaction chamber includes injecting the source plasma into an acceleration region defined between an inner electrode and an outer electrode of the plasma confinement device, the outer electrode surrounding the inner electrode and extending beyond the inner electrode along a Z-pinch axis to define an assembly region adjacent the acceleration region, the acceleration region and the assembly region forming the reaction chamber; and supplying power to the plasma confinement device includes applying the voltage between the inner electrode and the outer electrode to cause the source plasma to flow along the acceleration region and into the assembly region and to be compressed into the Z-pinch plasma along the Z-pinch axis in the assembly region.

In some embodiments, injecting the source plasma into the acceleration region includes injecting the source plasma at least in part from within the inner electrode through at least one plasma injector formed through the inner electrode and leading into the acceleration region. In some embodiments, injecting the source plasma into the acceleration region includes injecting the source plasma at least in part from outside the outer electrode through at least one plasma injector formed through the outer electrode and leading into the acceleration region. In some embodiments, injecting the source plasma into the acceleration region includes injecting the source plasma at least in part from outside the plasma confinement device through at least one plasma injector formed through a rear end wall of the plasma confinement device and leading into the acceleration region.

In some embodiments, forming the source plasma includes supplying a process gas into a plasma formation region of a plasma generator; and supplying power to the plasma generator to apply a voltage across the plasma formation region configured to energize the process gas into the source plasma; and introducing the source plasma inside the reaction chamber includes flowing the source plasma along a plasma transport channel extending between the plasma formation region and the reaction chamber. In some embodiments, the step of supplying the process gas into the plasma formation region is initiated before the step of supplying power to the plasma generator is initiated. In some embodiments, the step of supplying the process gas into the plasma formation region is initiated at the same time as or after the step of supplying power to the plasma generator is initiated. In some embodiments, the plasma generator includes an inner electrode and an outer electrode surrounding the inner electrode to define the plasma formation region therebetween, the outer electrode extending beyond the inner electrode to enclose the plasma transport channel. In some embodiments, the process gas includes deuterium, tritium, hydrogen, or helium, or any combination thereof.

In some embodiments, the source plasma is configured to flow in the plasma transport channel along a first flow direction and to flow along a second flow direction after injection inside the reaction chamber, the first flow direction and the second flow direction making an acute angle with respect to each other.

In some embodiments, the step of introducing the source plasma inside the reaction chamber is initiated before the step of supplying power to the plasma confinement device is initiated. In some embodiments, the step of introducing the source plasma inside the reaction chamber is initiated at the same time as or after the step of supplying power to the plasma confinement device is initiated.

In some embodiments, the plasma processing method further includes continuing the steps of introducing the source plasma inside the reaction chamber and supplying power to the plasma confinement device to feed and sustain the Z-pinch plasma after the Z-pinch plasma has been formed.

In some embodiments, supplying power to the plasma confinement device includes applying the voltage across the reaction chamber in a voltage range from about 1 kV to about 40 kV.

In some embodiments, the plasma processing method further includes maintaining stability of the Z-pinch plasma. In some embodiments, maintaining stability of the Z-pinch plasma includes embedding a sheared axial flow inside the Z-pinch plasma.

In some embodiments, the plasma processing method further includes generating nuclear fusion reactions inside the Z-pinch plasma in response to compression of the Z-pinch plasma. In some embodiments, the nuclear fusion reactions include neutronic fusion reactions.

In accordance with another aspect, there is provided a plasma processing system, including:
a plasma confinement device including a reaction chamber configured to generate therein a Z-pinch plasma along a Z-pinch axis;
a plasma formation and injection device configured to form a source plasma outside the reaction chamber and inject the source plasma inside the reaction chamber in the presence of the Z-pinch plasma; and
a main power supply configured to supply power to the plasma confinement device to apply a voltage across the reaction chamber configured to compress the source plasma to sustain the Z-pinch plasma along the Z-pinch axis.

In some embodiments, the plasma confinement device includes an inner electrode and an outer electrode surrounding the inner electrode to define an acceleration region therebetween, the outer electrode extending beyond the inner electrode along the Z-pinch axis to define an assembly region adjacent the acceleration region, the acceleration region and the assembly region forming the reaction chamber; the plasma formation and injection device is configured to inject the source plasma into the acceleration region; and the main power supply is configured to apply the voltage between the inner electrode and the outer electrode to cause the source plasma to flow along the acceleration region and into the assembly region to be compressed to feed and sustain the Z-pinch plasma along the Z-pinch axis.

In some embodiments, the plasma processing system further includes a startup neutral gas supply unit configured to supply a startup neutral gas into the acceleration region, wherein the main power supply is configured to apply a startup voltage between the inner electrode and the outer electrode to energize the startup neutral gas into a startup plasma and cause the startup plasma to flow along the acceleration region and into the assembly region and to be compressed into the Z-pinch plasma.

In some embodiments, the plasma formation and injection device includes a plasma generator configured to generate the source plasma; and a plasma injector configured to inject the source plasma into the acceleration region. In some embodiments, the plasma injector includes a plasma injection port formed through the inner electrode, through the outer electrode, or through a rear end wall of the plasma confinement device. In some embodiments, the plasma generator includes an inner electrode; and an outer electrode surrounding the inner electrode to define a plasma formation region therebetween, the outer electrode extending beyond the inner electrode along a plasma formation axis to enclose a plasma transport channel extending from the plasma formation region to the plasma injector along the plasma formation axis.

In some embodiments, the plasma formation and injection device includes a process gas supply unit configured to supply a process gas into the plasma formation region; and a plasma formation power supply configured to apply a voltage between the inner electrode and the outer electrode of the plasma generator to energize the process gas into the source plasma and cause the source plasma to flow along the plasma formation region and through the plasma transport channel to reach the plasma injector for injection of the source plasma into the acceleration region.

In accordance with another aspect, there is provided a plasma processing method, including: forming a Z-pinch plasma inside a reaction chamber of a plasma confinement device;
forming a source plasma outside the reaction chamber;
introducing the source plasma inside the reaction chamber; and
supplying power to the plasma confinement device to apply a voltage across the reaction chamber configured to compress the source plasma to feed and sustain the Z-pinch plasma.

In some embodiments, forming the Z-pinch plasma includes supplying a startup neutral gas inside the reaction chamber; and energizing and compressing the startup neutral gas into the Z-pinch plasma.

In some embodiments, the plasma processing method further includes stopping the step of supplying the startup neutral gas inside the reaction chamber once the Z-pinch plasma has been formed and the step of introducing the source plasma inside the reaction chamber has been initiated.

In some embodiments, introducing the source plasma inside the reaction chamber includes injecting the source plasma into an acceleration region defined between an inner electrode and an outer electrode of the plasma confinement device, the outer electrode surrounding the inner electrode and extending beyond the inner electrode along a Z-pinch axis to define an assembly region adjacent the acceleration region, the acceleration region and the assembly region forming the reaction chamber; and supplying power to the plasma confinement device includes applying the voltage between the inner electrode and the outer electrode to cause the source plasma to flow along the acceleration region and into the assembly region to be compressed to feed and sustain the Z-pinch plasma along the Z-pinch axis.

In some embodiments, forming the source plasma includes supplying a process gas into a plasma formation region of a plasma generator; and supplying power to the plasma generator to apply a voltage across the plasma formation region configured to energize the process gas into the source plasma; and introducing the source plasma inside the reaction chamber includes flowing the source plasma along a plasma transport channel extending between the plasma formation region and the reaction chamber. In some embodiments, the plasma generator includes an inner electrode; and an outer electrode surrounding the inner electrode to define the plasma formation region therebetween, the outer electrode extending beyond the inner electrode to enclose the plasma transport channel.

In some embodiments, the plasma processing method further includes maintaining stability of the Z-pinch plasma by embedding a sheared axial flow inside the Z-pinch plasma.

In some embodiments, the plasma processing method further includes generating nuclear fusion reactions inside the Z-pinch plasma in response to compression of the Z-pinch plasma. In some embodiments, the nuclear fusion reactions include neutronic fusion reactions.

In accordance with another aspect, there is provided a plasma processing system, including: a plasma confinement device including a reaction chamber; a plasma formation and injection device configured to form a source plasma outside the reaction chamber and inject the source plasma inside the reaction chamber; and a main power supply configured to supply power to the plasma confinement device to apply a voltage across the reaction chamber configured to compress the source plasma to form and/or feed and sustain a Z-pinch plasma.

In accordance with another aspect, there is provided the plasma processing method, including: forming a source plasma outside a reaction chamber of a plasma confinement device; introducing the source plasma inside the reaction chamber; and supplying power to the plasma confinement device to apply a voltage across the reaction chamber configured to compress the source plasma to form and/or feed and sustain a Z-pinch plasma.

In some embodiments, there is provided a plasma processing system for nuclear fusion generation, including: a plasma confinement device; and a plasma formation and injection device disposed outside the plasma confinement device and configured to form an initial or source plasma and inject the initial plasma inside the plasma confinement device, wherein the plasma confinement device is configured to compress the initial plasma into a Z-pinch plasma at fusion conditions.

In some embodiments, there is provided a plasma processing method for nuclear fusion generation, including: forming an initial plasma; injecting the initial plasma inside a plasma confinement device; and compressing the initial plasma into a Z-pinch plasma to reach fusion conditions.

In some embodiments, there is provided a plasma processing system, including a plasma confinement device and a plasma formation and injection device. The plasma confinement device has a longitudinal axis and includes an inner electrode; and an outer electrode surrounding the inner electrode to define an acceleration region therebetween, the outer electrode extending beyond the inner electrode along the longitudinal axis to define an assembly region adjacent the acceleration region. The plasma formation and injection device is provided externally of the acceleration region and configured to form an initial plasma outside the acceleration region and inject the initial plasma in the acceleration region, wherein applying, with a power supply, an electric potential difference between the inner electrode and the outer electrode causes the initial plasma to flow along the acceleration region and into the assembly region to be compressed into a Z-pinch plasma. In some embodiments, the Z-pinch plasma has a sheared axial flow, thus forming a sheared-flow Z-pinch or flow-through pinch plasma. In some embodiments, the Z-pinch plasma is compressed sufficiently to generate nuclear fusion reactions therein. In some embodiments, the nuclear fusion reactions produce neutrons.

In some embodiments, there is provided a plasma process method, including forming an initial plasma; injecting the initial plasma into an acceleration region defined between an inner electrode and an outer electrode surrounding the inner electrode, the outer electrode extending longitudinally beyond the inner electrode to define an assembly region adjacent the acceleration region; and applying an electric potential difference between the inner electrode and the outer electrode to cause the initial plasma to flow along the acceleration region and into the assembly region where the initial plasma is compressed into a Z-pinch plasma.

Other method and process steps may be performed prior, during, or after the steps described herein. The order of one or more steps may also differ, and some of the steps may be omitted, repeated, and/or combined, as the case may be.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIGS. 1 to 5 are schematic representations of a conventional Z-pinch plasma confinement device at five different stages of the Z-pinch formation.

FIG. 6 is a flow diagram of a plasma processing method, in accordance with an embodiment.

FIG. 7 is a schematic longitudinal cross-sectional view of a plasma processing system, in accordance with an embodiment.

FIG. 8 is a schematic longitudinal cross-sectional view of a plasma processing system, in accordance with another embodiment.

FIG. 9 is a schematic front cross-sectional view of a plasma processing system, in accordance with another embodiment.

FIG. 10 is a schematic longitudinal cross-sectional view of a plasma processing system, in accordance with another embodiment.

FIG. 11 is a schematic longitudinal cross-sectional view of a plasma processing system, in accordance with another embodiment.

FIG. 12 is a schematic longitudinal cross-sectional view of a plasma processing system, in accordance with another embodiment.

FIG. 13 is a schematic longitudinal cross-sectional view of a plasma processing system, in accordance with another embodiment.

FIG. 14 is a schematic longitudinal cross-sectional view of a plasma processing system, in accordance with another embodiment.

FIG. 15 is a schematic longitudinal cross-sectional view of a plasma processing system, in accordance with another embodiment.

FIGS. 16A and 16B are schematic longitudinal cross-sectionals view of a plasma processing system, in accordance with another embodiment, depicted at two different operation stages.

FIG. 17 is a flow diagram of a plasma processing method, in accordance with another embodiment.

FIGS. 18A to 18E depict five different stages of a method of operating a plasma processing system to generate a Z-pinch plasma, in accordance with another embodiment.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of ±10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based in part on”. In particular, the term “based on” may also be understood as meaning “depending on”, “representative of”, “indicative of”, “associated with”, “relating to”, and the like.

The terms “match”, “matching”, and “matched” refer herein to a condition in which two elements are either the same or within some predetermined tolerance of each other. That is, these terms are meant to encompass not only “exactly” or “identically” matching the two elements but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, logical, fluidic, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

The present description generally relates to plasma injection and confinement techniques for use in fusion power generation. The present techniques can find use in various fields and applications including, to name a few, fusion power generation, plasma sources, ion sources, plasma accelerators, neutron and high-energy photon generation, materials processing, and fusion-based medical devices.

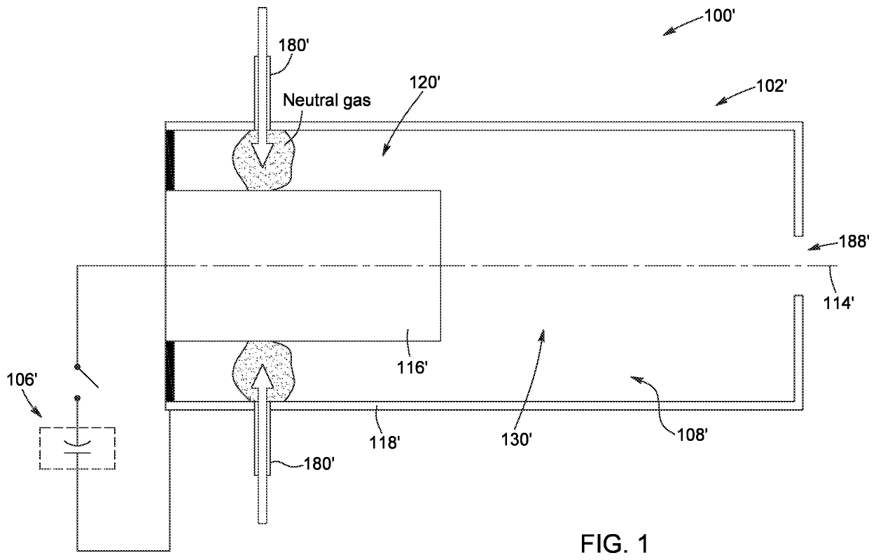

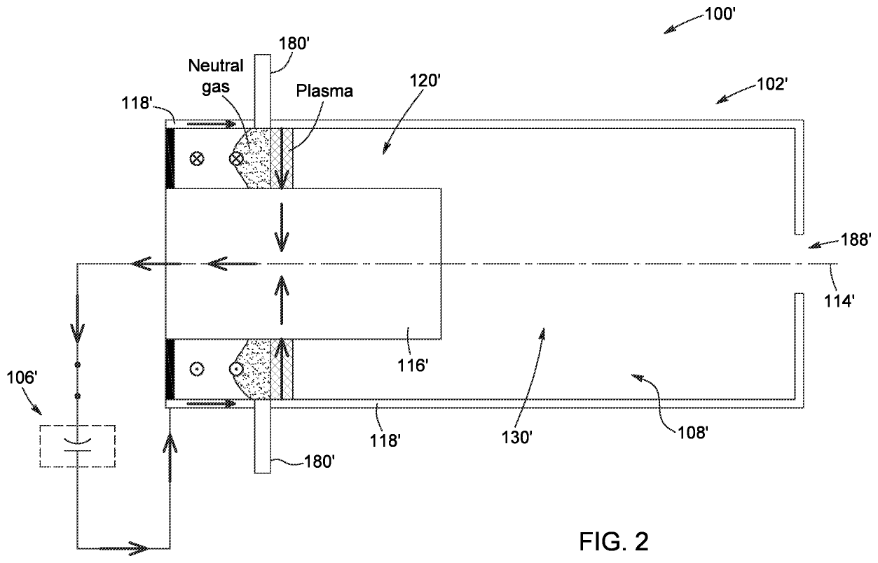

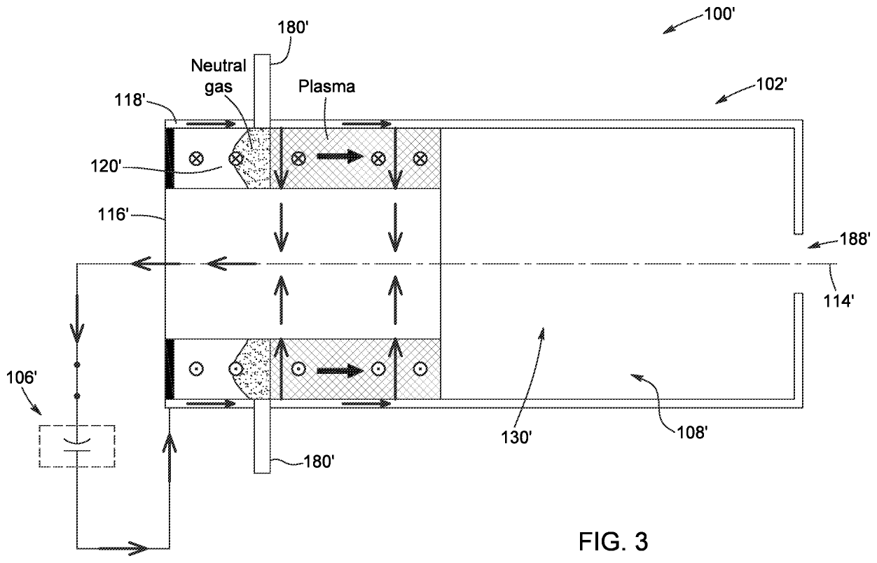

Magnetic plasma confinement is one of several approaches to achieving controlled fusion for power generation. Different types of configurations for magnetic plasma confinement have been devised and studied over the years, among which is the Z-pinch configuration. Referring to FIGS. 1 to 5, there are provided schematic representations of a conventional Z-pinch plasma processing system 100′ at different stages of the Z-pinch formation. The plasma processing system 100′ includes a plasma confinement device 102′ and a power supply 106′ configured to supply power to the plasma confinement device 102′. The plasma confinement device 102′ includes an inner electrode 116′ and an outer electrode 118′. The inner electrode 116′ and the outer electrode 118′ form a coaxial electrode arrangement extending along a longitudinal Z-pinch axis 114′. In the illustrated configuration, the outer electrode 118′ extends longitudinally beyond the inner electrode 116′. The annular volume extending between the inner electrode 116′ and the outer electrode 118′ defines a plasma acceleration region 120′, while the cylindrical volume surrounded by the outer electrode 118′ and extending beyond the inner electrode 116′ defines a Z-pinch assembly region 130′. The plasma acceleration region 120′ and the Z-pinch assembly region 130′ define a reaction chamber 108′. The formation of a Z-pinch plasma involves injecting neutral gas in the acceleration region 120′ (FIG. 1), and applying, using the power supply 106′, an electric potential difference between the inner electrode 116′ and the outer electrode 118′ (FIG. 2). The neutral gas can be injected into the acceleration region 120′ via one or more gas injection ports 180′ of the plasma confinement device 102′ (e.g., formed through the peripheral surface of the outer electrode 118′), the one or more gas injection ports 180′ being connected to a gas supply system including a neutral gas source (not shown). The power supply 106′ can include a high-voltage capacitor bank and a switch. The electric potential difference applied between the inner electrode 116′ and the outer electrode 118′ is configured to ionize the neutral gas, resulting in the formation of an annular column or washer of plasma in the acceleration region 120′. The plasma column allows electric current to flow radially therethrough between the electrodes 116′, 118′ (FIG. 2). The electric current that flows axially along the inner electrode 116′ generates an azimuthal magnetic field in the acceleration region 120′ (FIG. 3).

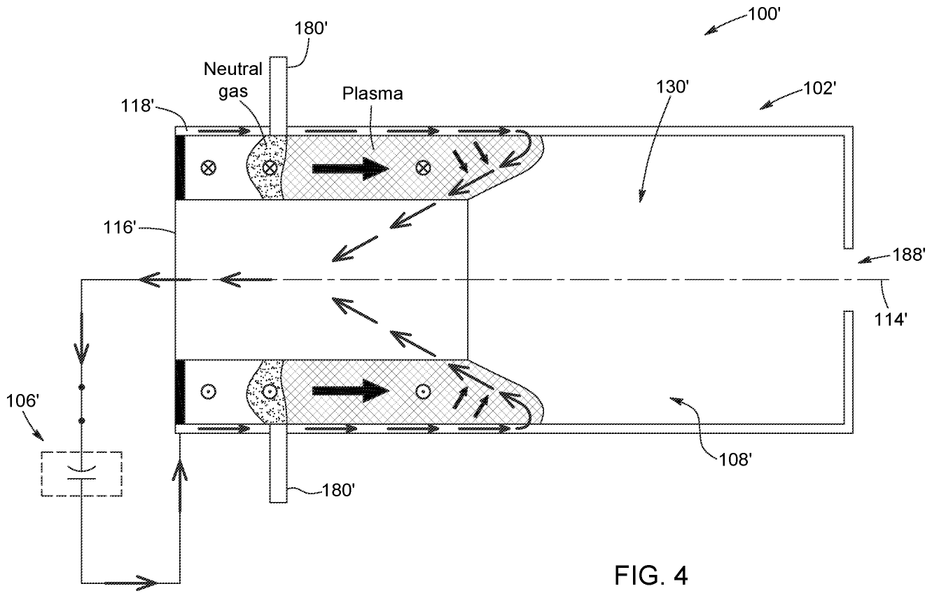

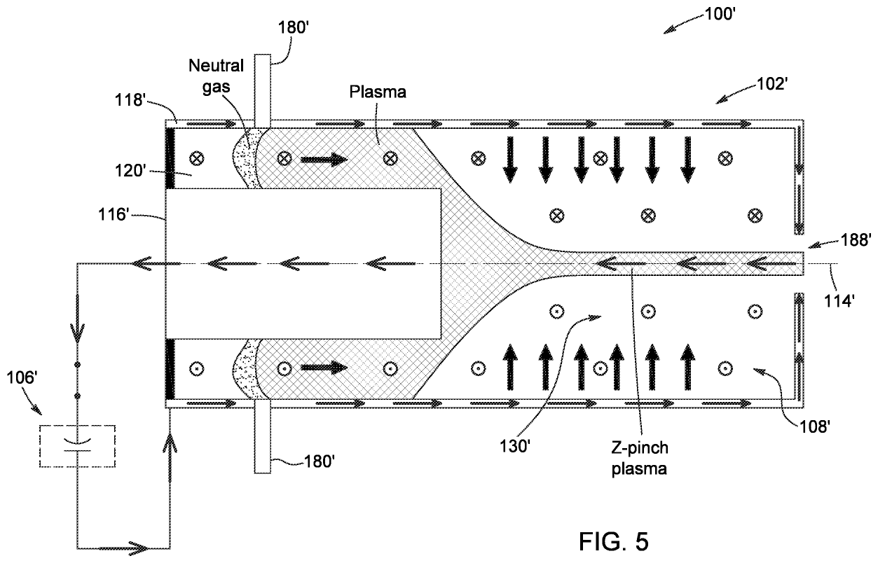

The interaction between the radial electric current flowing in the plasma column and the azimuthal magnetic field produces a Lorentz force in the axial direction that pushes and accelerates the plasma column axially forward along the acceleration region 120′ (FIG. 3) until the plasma column reaches the entrance of the assembly region 130′ and the Z-pinch formation begins (FIG. 4). In the assembly region 130′, the direction of the Lorentz force changes from longitudinal to radially inward, which makes the plasma column collapse inwardly toward the Z-pinch axis 114′ to complete the formation of the Z-pinch plasma (FIG. 5). The axial current flowing in the Z-pinch plasma generates an azimuthal magnetic field that exerts an inward magnetic pressure and an inward magnetic tension, which radially compress the Z-pinch plasma against the outward plasma pressure until an equilibrium is established. In this configuration, the Z-pinch plasma can continue to form and move along the Z-pinch assembly region 130′ for as long as neutral gas is supplied and ionized in the acceleration region 120′.

By increasing the axial current to compress the Z-pinch plasma to sufficiently high density and temperature, fusion reactions can be achieved within the pinch, resulting in an exothermic energy release. In many applications, fusion reactions release their energy in the form of neutrons. A commonly used fusion reaction is the deuterium-tritium reaction, or D-T reaction, in which the fusion of one deuterium nucleus and one tritium nucleus produces one alpha particle and one neutron. Being chargeless, neutrons can escape from the magnetically confined plasma pinch and transfer their kinetic energy into thermal energy after they exit the confinement region. This thermal energy can be converted into electricity, for example, by transferring the heat generated to a working fluid used by a heat engine for generating electrical energy. The remaining fusion products have kinetic energy that can contribute more energy to the fusion process.

Conventional Z-pinch configurations are unstable due to the presence of magnetohydrodynamic (MHD) instabilities. A challenge in Z-pinch fusion research is devising ways of improving the control of instabilities to keep Z-pinch plasmas confined long enough to sustain ongoing fusion reactions. Techniques such as close fitting walls, axial magnetic fields, and pressure profile control have been proposed, with mitigated results. Recent advances have demonstrated that sheared plasma flows—that is, plasma flows with a radius-dependent axial velocity—can provide a promising stabilization approach to achieving and sustaining fusion conditions in Z-pinch configurations. One of the keys to unlocking the potential of sheared-flow-stabilized Z-pinch fusion devices as these devices are scaled up in power input—and thus in power output—is to mitigate, circumvent, or otherwise control instabilities, turbulence, heat transfer, and other factors limiting plasma lifetime. This is because once the reaction becomes unstable, the pinch ceases, neutron production stops, and power generation shuts down. Researchers have theorized that fusion conditions resulting in viable net power output that can be met at high power input are achievable when the flow shear exceeds a certain threshold above which the Z-pinch is stable, this threshold depending on the magnetic field strength and the plasma density. It is appreciated that the theory, instrumentation, implementation, and operation of conventional sheared-flow-stabilized Z-pinch plasma confinement devices are generally known in the art and need not be described in detail herein other than to facilitate an understanding of the present techniques. Reference is made in this regard to international patent application PCT/US2018/019364 (published as WO 2018/156860) as well as the following doctoral dissertation: Golingo, Raymond, Formation of a Sheared Flow Z-Pinch (University of Washington, 2003). The contents of these two documents are incorporated herein by reference in their entirety.

In some embodiments, the present techniques provide a plasma processing method for use in nuclear fusion power generation. The plasma processing method can include steps of forming a source or initial plasma, introducing the source plasma inside a plasma confinement device, and compressing the source plasma introduced inside the plasma confinement device to form and/or sustain a Z-pinch plasma at fusion conditions. In some embodiments, the source plasma is injected into the plasma confinement device to be compressed into a Z-pinch plasma, and the injection of the source plasma is maintained throughout the lifetime of the Z-pinch plasma to sustain the Z-pinch plasma. In other embodiments, the source plasma is injected into the plasma confinement device to feed and sustain a pre-existing Z-pinch plasma, where the pre-existing Z-pinch plasma may have been formed by a Z-pinch startup operation such as that illustrated in FIGS. 1 to 5, which involves neutral gas injection, ionization, acceleration, and compression. The method may be implemented in a plasma processing system that includes a power supply, a plasma confinement device coupled to the power supply and including a reaction chamber, and a plasma formation and injection device configured to form a source plasma outside the reaction chamber and inject the source plasma the inside reaction chamber. The power supply is configured to supply power to the plasma confinement device so as to apply a voltage or electric potential difference across the reaction chamber, the voltage being configured to compress the source plasma to form and/sustain a Z-pinch plasma configured to reach fusion conditions. Depending on the application, the plasma formation and injection device can include a single plasma generator and a single plasma injector; a single plasma generator and a plurality of plasma injectors; a plurality of plasma generators and a single plasma injector; or a plurality of plasma generators and a plurality of plasma injectors.

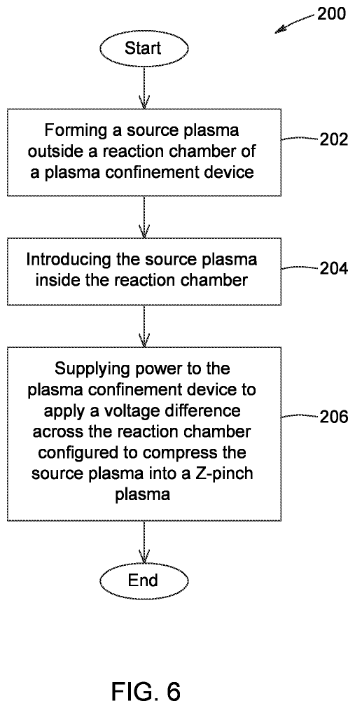

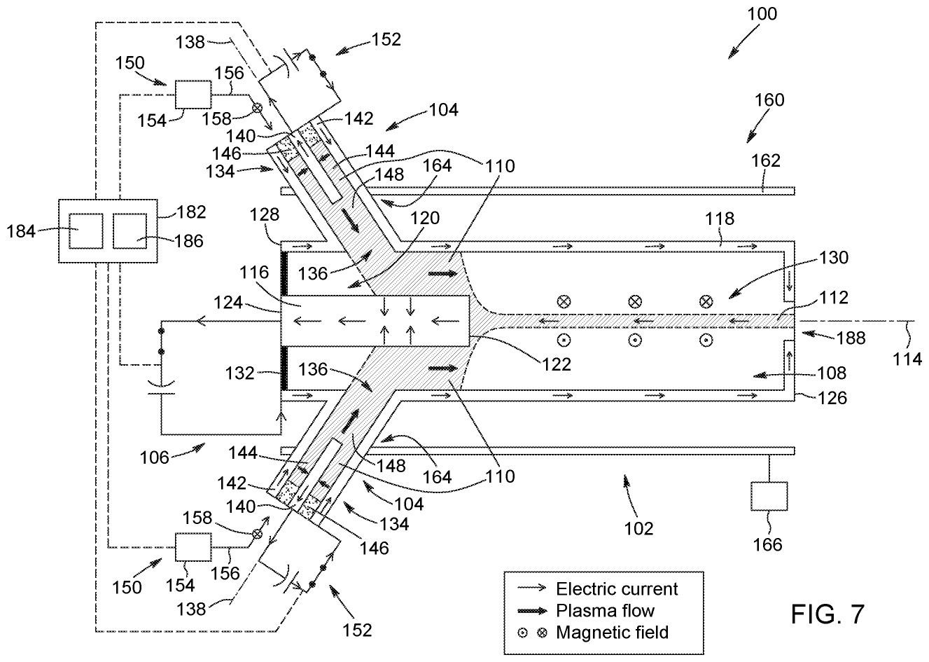

Referring to FIG. 6, there is illustrated a flow diagram of a plasma processing method 200, in accordance with an embodiment. The method 200 of FIG. 6 may be implemented in a plasma processing system 100 such as the ones depicted in FIGS. 7 to 18E, or another suitable plasma processing system. Broadly described, the method 200 of FIG. 6 includes a step 202 of forming a source or initial plasma outside a reaction chamber of a plasma confinement device, a step 204 of introducing the source plasma inside the reaction chamber, and step 206 of supplying power to the plasma confinement device to apply a voltage or electric potential difference across the reaction chamber to compress the source plasma into a Z-pinch plasma. In some embodiments, the introducing step 204 can include injecting the source plasma into an acceleration region defined between an inner electrode and an outer electrode of the plasma confinement device, where the outer electrode surrounds the inner electrode and extends axially beyond the inner electrode to define an assembly region adjacent the acceleration region, and where the acceleration region and the assembly region form the reaction chamber. In some embodiments, the supplying step 206 can include applying the voltage between the inner electrode and the outer electrode to cause the source plasma to flow along the acceleration region and into the assembly region and to be compressed into the Z-pinch plasma in the assembly region. In some embodiments, the introducing step 204 and the supplying step 206 are continued or maintained after the Z-pinch plasma has been formed so as to sustain the Z-pinch plasma. In some embodiments, the method 200 can include maintaining stability of the Z-pinch plasma, for example, by embedding a sheared axial flow inside the Z-pinch plasma.

In the present techniques, a source plasma is formed outside the reaction chamber of a plasma confinement device, and the externally formed source plasma is transported, injected, introduced, or otherwise coupled into the reaction chamber where it is compressed into a Z-pinch plasma. It is appreciated that this approach differs from conventional flow-through or sheared-flow-stabilized Z-pinch plasma confinement approaches. In such approaches, a source plasma is formed inside an acceleration region of a reaction chamber, typically by injection and ionization of neutral gas, and this internally formed plasma is flowed along the acceleration region and into an assembly region of the reaction chamber to be compressed into a Z-pinch plasma. In these conventional approaches, the temperature, density, lifetime, and other parameters of the Z-pinch plasma are largely controlled by the neutral gas profile (e.g., spatial density profile) inside the plasma confinement device. However, plasma formation from a neutral gas is a complex, time-dependent process, which can make controlling the Z-pinch parameters challenging. In contrast, by injecting an externally and already formed plasma inside the reaction chamber of a plasma confinement device, the present techniques can allow the plasma formation and sustainment process to be controlled largely independently from the plasma acceleration and compression process. This independent control can in turn provide enhanced control over the Z-pinch parameters and properties (e.g., plasma density, temperature, velocity, stability, lifetime, magnetic field, and the like). Fusion conditions can therefore be established in the Z-pinch plasma as a result of two largely decoupled and separately controlled processes. In particular, controlled plasma injection can allow for a stable Z-pinch plasma to provide higher fusion power gain sustained over longer periods of time, with reduced or better controlled power losses and other energy inefficiencies.

Referring to FIG. 7, there is illustrated a schematic longitudinal cross-sectional view of a plasma processing system 100, in accordance with an embodiment. The plasma processing system 100 can be used for generating thermonuclear fusion reactions, for example, neutronic fusion reactions. The plasma processing system 100 of FIG. 7 generally includes a plasma confinement device 102, a plasma formation and injection device 104, and a main power supply 106. The plasma confinement device 102 includes a reaction chamber 108. The plasma formation and injection device 104 is coupled to, but disposed externally of, the reaction chamber 108 of the plasma confinement device 102. The plasma formation and injection device 104 is configured to generate a source plasma 110 outside the reaction chamber 108 and to introduce, inject, or otherwise couple the source plasma 110 inside the reaction chamber 108. The main power supply 106 is configured to supply electric power to the plasma confinement device 102 to apply a voltage across the reaction chamber 108 to cause the source plasma 110 to be compressed into a Z-pinch plasma 112 and to sustain the Z-pinch plasma 112. In some applications, the plasma processing system 100 is configured to compress and heat the Z-pinch plasma 112 sufficiently to reach fusion conditions, that is, plasma density and temperature conditions at which fusion reactions occur inside the Z-pinch plasma 112. In such applications, the energy produced by the fusion reactions, which typically involve the generation of neutrons, exceeds the input energy required to establish fusion conditions.

More detail regarding the structure, configuration, and operation of these components and other possible components of the plasma processing system 100 are provided below. It is appreciated that FIG. 7 is a simplified schematic representation that illustrates certain features and components of the plasma processing system 100, such that additional features and components that may be useful or necessary for its practical operation may not be specifically depicted. Non-limiting examples of such additional features and components can include, to name a few, power supplies, electrical connections, gas sources, gas supply lines (e.g., conduits, such as pipes or tubes), pressure and flow control devices (e.g., pumps, valves, regulators, restrictors), operation monitoring and diagnostic devices (e.g., sensors), processors and controllers, and other standard hardware and equipment.

In FIG. 7, the plasma confinement device 102 has a longitudinal axis 114, or Z-pinch axis, along which the Z-pinch plasma 112 is confined. The term “Z-pinch plasma” broadly refers herein to a plasma that has an electric current flowing substantially along the longitudinal or axial direction Z of a cylindrical coordinate system. The axial electrical current generates an azimuthal magnetic field that radially compresses, or pinches, the plasma by the Lorentz force. It is appreciated that in some instances, terms such as “Z-pinch”, “zeta pinch”, “plasma pinch”, “pinch”, “plasma arc” may be used interchangeably with the term “Z-pinch plasma”.

The plasma confinement device 102 includes an inner electrode 116 and an outer electrode 118 surrounding the inner electrode 116 to define a plasma acceleration region 120 therebetween. In the illustrated embodiment, the inner electrode 116 and the outer electrode 118 each have an elongated configuration along the Z-pinch axis 114. The inner electrode 116 has a front end 122 and a rear end 124, and the outer electrode 118 has a front end 126 and a rear end 128. The outer electrode 118 extends forwardly beyond the inner electrode 116 along the Z-pinch axis 114 to define a Z-pinch assembly region 130 adjacent the acceleration region 120. The volume occupied by the acceleration region 120 and the assembly region 130 defines the reaction chamber 108 of the plasma confinement device 102.

In the illustrated arrangement, the inner electrode 116 and the outer electrode 118 both have a substantially cylindrical configuration, with a circular cross-section transverse to the Z-pinch axis 114, and the outer electrode 118 encloses the inner electrode 116 in a coaxial arrangement with respect to the Z-pinch axis 114. However, various other electrode configurations may be used in other embodiments. Non-limiting examples include, to name a few, non-coaxial arrangements, non-circularly symmetric transverse cross-sections, three-electrode arrangements, and the like. In some embodiments, the inner electrode 116 may have a length ranging from about 25 cm to about one or a few meters and a radius ranging from about 2 cm to about 1 mm, while the outer electrode 118 may have a length ranging from about 50 cm to about 6 m, a radius ranging from about 6 cm to about 2 m or more, and a wall thickness ranging from about 6 mm to about 12 mm, although other electrode dimensions may be used in other embodiments. Depending on the application, the inner electrode may have a full or hollow configuration. The inner electrode 116 and the outer electrode 118 may each be made of any suitable electrically conductive material, such as various metals and metal alloys. Non-limiting examples include, to name a few, tungsten-coated copper and graphite. It is appreciated that the size, shape, composition, structure, and arrangement of the inner electrode 116 and the outer electrode 118 can be varied depending on the application.

The plasma confinement device 102 can also include an electrode insulator 132 disposed between the inner electrode 116 and the outer electrode 118. The electrode insulator 132 is configured to provide electrical insulation between the inner electrode 116 and the outer electrode 118 so as to prevent or help prevent unwanted charge buildup and other undesirable electrical phenomena that could adversely affect the operation of the plasma confinement device 102. In the illustrated embodiment, the electrode insulator 132 has an annular cross-sectional shape and is disposed near the rear ends 124, 128 of the inner and outer electrodes 116, 118. The electrode insulator 132 may be made of any suitable electrically insulating material, for example, glass, ceramic, and glass-ceramic materials.

Referring still to FIG. 7, the acceleration region 120 has a substantially annular cross-sectional shape defined by the cross-sectional shapes of the inner and outer electrodes 116, 118. The acceleration region 120 is configured to receive the source plasma 110 from the plasma formation and injection device 104 and allow the source plasma 110 to flow along the acceleration region 120 and into the assembly region 130. In some embodiments, the acceleration region 120 may have a length ranging from about 25 cm to about 1.5 m and an annular thickness from about 2 cm to about 10 cm, although other dimensions may be used in other embodiments.

In the illustrated embodiment, the assembly region 130 has a substantially circular cross-sectional shape defined by the cross-sectional shape of the portion of the outer electrode 118 that projects axially beyond the inner electrode 116. The assembly region 130 generally extends between the front end 122 of the inner electrode 116 and the front end 126 of the outer electrode 118. In the illustrated embodiment, the front end 122 of the inner electrode 116 is flat, and the front end 126 of the outer electrode 118 defines a front end wall of the plasma confinement device 102. However, non-flat geometries (e.g., half-spherical, conical, tapered, either concave or convex) for the front end 122 of the inner electrode 116 and/or the front end 126 of the outer electrode 118 are possible in other embodiments. The assembly region 130 is configured to sustain the Z-pinch plasma 112 along the Z-pinch axis 114 between the front end 122 of the inner electrode 116 and the front end 126 of the outer electrode 118. In some embodiments, the assembly region 130 may have a length ranging from about 25 cm to about 3 m or more, although other dimensions may be used in other embodiments. In some embodiments, the plasma confinement device 102 may include a plasma exit port 188 configured to allow part of the Z-pinch plasma 112 to exit the plasma confinement device 102, so as to avoid a stagnation point in the plasma flow that could create instabilities and destroy the Z-pinch plasma 112. In the illustrated embodiment, the plasma exit port 188 is provided as a hole formed on the Z-pinch axis 114 at a front end wall of the outer electrode 118. In other embodiments, the plasma exit port 188 may provided at other locations of the plasma confinement device 102, for example, through the peripheral wall of the outer electrode 118. In yet other embodiments, a plurality of plasma exit ports may be provided.

Referring still to FIG. 7, the main power supply 106 is connected to the inner electrode 116 and the outer electrode 118 via appropriate electrical connections. The term “power supply” refers herein to any device or combination of devices configured to supply electrical power into a form usable by another device or combination of devices. It is appreciated that while the main power supply 106 depicted as a single entity for illustrative purposes, the term “power supply” should not be construed as being limited to a single power supply and, accordingly, in some embodiments the main power supply 106 may include a plurality of power supply units. In some instances, the main power supply 106 coupled to the plasma confinement device 102 may be referred to as an “acceleration and compression power supply” to more clearly distinguish it from other power supplies of the plasma processing system 100.

In some embodiments, the main power supply 106 may be a switching pulsed-DC power supply and may include an energy source (e.g., a capacitor bank, such as in FIG. 7), a switch (e.g., a spark gap, an ignitron, or a semiconductor switch), and a pulse shaping network (including, e.g., inductors, resistors, diodes, and the like). Depending on the application, the main power supply 106 may be voltage-controlled or current-controlled. In other embodiments, other suitable types of power supplies may be used, including DC and AC power supplies. Non-limiting examples include, to name a few, DC grids, voltage source converters, and homopolar generators. The main power supply 106 is configured to apply power to the plasma confinement device 102 in order to apply voltage between the inner and outer electrodes 116, 118. The voltage is configured to generate an accelerating electric field in the acceleration region 120 that causes the source plasma 110 to flow along the acceleration region 120 and into the assembly region 130 and to be compressed into the first Z-pinch plasma 112 in the assembly region 130. In some embodiments, the voltage applied between the inner and outer electrodes 116, 118 may range from about 1 kV to about 40 kV, although other voltage values may be used in other embodiments. In some embodiments, the voltage may be applied as a voltage pulse of duration ranging from 100 μs to about 1 to 10 ms, although other pulse duration values may be used in other embodiments. The operation of the main power supply 106 may be selected in view of the parameters of the source plasma 110 injected within the acceleration region 120 and the configuration and operating conditions of the plasma confinement device 102 in order to favor the acceleration of the source plasma 110 along the acceleration region 120 and the compression of the source plasma 110 into the Z-pinch plasma 112 in the assembly region 130. Depending on the application, the operation of introducing the source plasma 110 into the acceleration region 120 can be initiated before, at the same time as, or after initiating the operation of activating the main power supply 106 to apply the voltage between the inner electrode 116 and the outer electrode 118.

It is appreciated that the plasma confinement device depicted in FIG. 7 is provided by way of example only, and that various other structures and configurations are contemplated in other embodiments.

Referring still to FIG. 7, the plasma formation and injection device 104 is disposed outside the reaction chamber 108 of the plasma confinement device 102, that is, outside both the acceleration region 120 and the assembly region 130. The plasma formation and injection device 104 is configured to form the source plasma 110 outside the reaction chamber 108 and to inject the source plasma 110 inside the reaction chamber 108, more specifically inside the acceleration region 120.

In some embodiments, the source plasma 110 may have the following properties and parameters: an electron temperature ranging from about 1 eV to about 100 eV, an ion temperature ranging from about 1 eV to about 100 eV, an electron density ranging from about 10¹³ cm⁻³ to about 10¹⁶ cm⁻³, an ion density ranging from about 10¹³ cm⁻³ to about 10¹⁶ cm⁻³, and a degree of ionization ranging from about 50% to about 100%. Depending on the application, the source plasma 110 may be magnetized or unmagnetized.

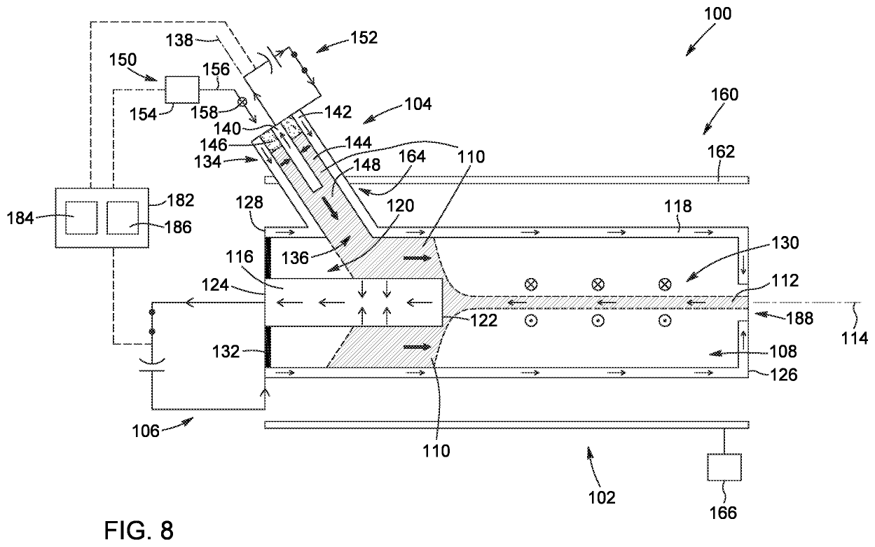

In FIG. 7, the plasma formation and injection device 104 includes two distinct plasma generators or sources 134 and two respective plasma injectors or couplers 136, so that each generator-injector pair contributes a respective portion of the source plasma 110 injected into the acceleration region 120 of the plasma confinement device 102. Referring to FIGS. 8 to 10, in other embodiments, the number of plasma generators 134 and the number plasma injectors 136 need not be equal to each other and/or equal to two. It is appreciated that the plasma processing system 100 in each of the embodiments of FIGS. 8 to 10 shares several features with the plasma processing system 100 of the embodiment of FIG. 7, which will not be described again other than to highlight differences between them.

In FIG. 8, the plasma formation and injection device 104 includes a single plasma generator 134 and a single plasma injector 136. The single plasma generator 134 is configured as a coaxial plasma gun and the single plasma injector 136 is provided as a plasma injection port formed through the outer electrode 118 of the plasma confinement device 102.

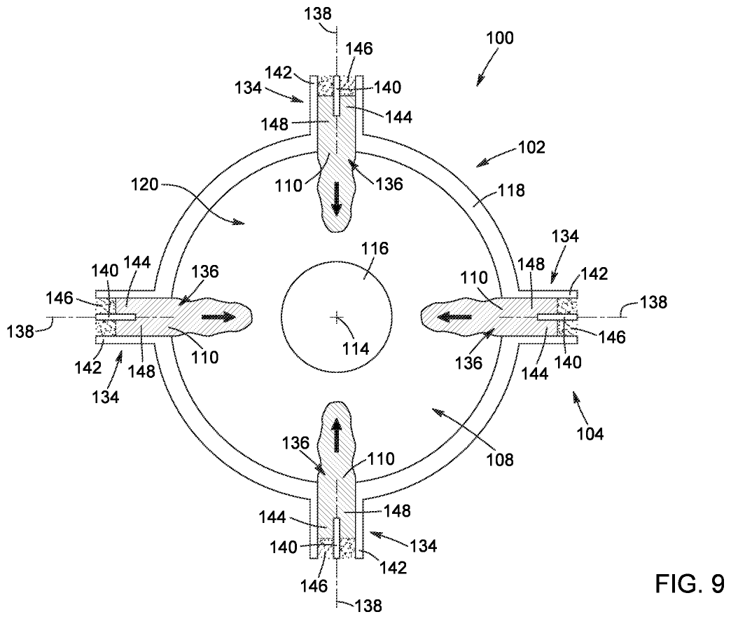

In FIG. 9 the plasma formation and injection device 104 includes more than two generator-injector pairs, namely four plasma generators 134 configured as four coaxial plasma guns and four corresponding plasma injectors 136 provided as four plasma injection ports formed through the outer electrode 118 of the plasma confinement device 102. In the illustrated embodiment, the four generator-injector pairs 134, 136 are disposed in an azimuthally symmetric arrangement with respect to the Z-pinch axis 114 of the plasma confinement device 102.

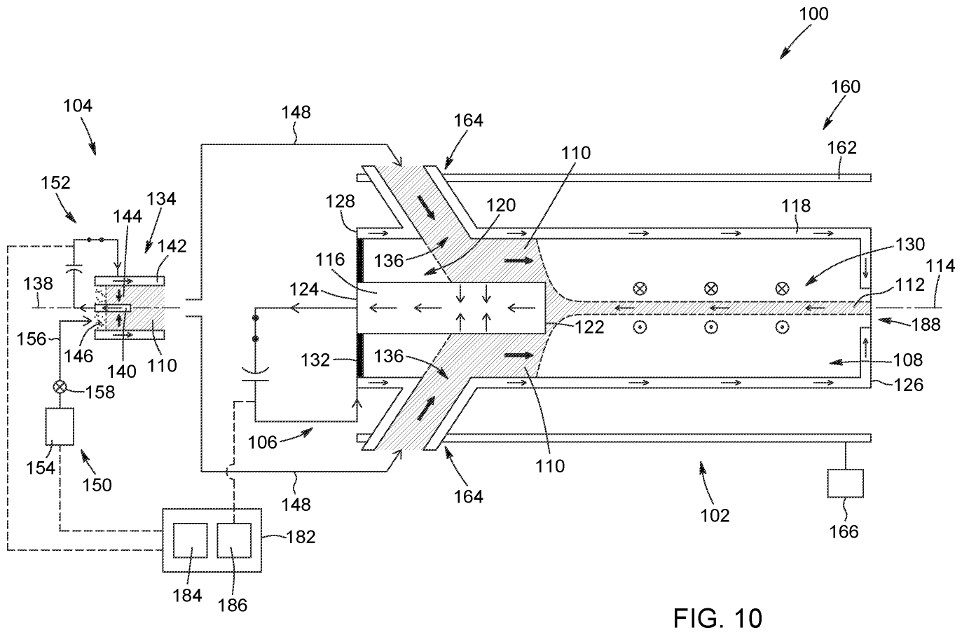

In FIG. 10 the plasma formation and injection device 104 includes a single plasma generator 134 and multiple plasma injectors 136. The single plasma generator 134 is configured as a coaxial plasma gun and the multiple plasma injectors 136 provided as two plasma injection ports formed through the outer electrode 118 of the plasma confinement device 102 at diametrically opposed azimuthal positions.

It is appreciated that, in general, the plasma formation and injection device 104 may include m plasma generator(s) and n plasma injector(s), where m and n are positive integers, and where m and n may or may not be identical to each other.

Returning to FIG. 7, it is appreciated that many plasma formation and generation techniques exist, notably in fusion power applications, and may be used in the embodiments disclosed herein to form the source plasma 110 with desired or required properties. In particular, the theory, instrumentation, implementation, and operation of plasma sources and are generally known in the art and need not be described in detail herein other than to facilitate an understanding of the present techniques.

In FIG. 7, each of the two plasma generators 134 of the plasma formation and injection device 104 is configured as a coaxial plasma gun. It is appreciated, however, that other types of electromagnetic plasma generators can be used in other embodiments. Coaxial plasma guns and other electromagnetic plasma generators generally operate by using the electric field generated by a high-voltage power supply to energize a gas into a plasma, and by relying on the Lorentz force to propel the plasma toward an outlet of the plasma gun. In the illustrated embodiment, each coaxial plasma generator 134 has a longitudinal plasma formation axis 138 and includes an inner electrode 140 and an outer electrode 142 disposed around the inner electrode 140 in a coaxial arrangement with respect to the plasma formation axis 138. In addition, the outer electrode 142 projects longitudinally beyond the inner electrode 140 and terminates at the plasma injector 136. In some embodiments, the inner electrode 140 may have a length ranging from about 75 mm to about 250 mm and a radius ranging from about 2 mm to about 7.5 mm, while the outer electrode 142 may have a length ranging from about 75 mm to about 275 mm, a radius ranging from about 12 mm to about 25 mm, and a wall thickness ranging from about 2.5 mm to about 7.5 mm, although other electrode dimensions may be used in other embodiments. The annular volume extending between the inner electrode 140 and the outer electrode 142 defines a plasma formation region 144 configured to receive a process gas 146 (e.g., a neutral gas or another plasma precursor gas) for the process gas 146 to be energized into the source plasma 110. The cylindrical volume surrounded by the outer electrode 142 and extending longitudinally beyond the front end of the inner electrode 140 defines a plasma transport channel 148 of the plasma generator 134, which extends from the plasma formation region 144 to the plasma injector 136 along the plasma formation axis 138. It is appreciated that despite both having a coaxial electrode arrangements, the plasma generators 134 of the plasma formation and injection device 104 is operated in a different manner than the plasma confinement device 102. For example, the plasma generators 134 may be operated as plasma deflagration guns and will generally not form the source plasma 110 as a pinch.

The process gas 146 can be any suitable gas or gas mixture capable of being energized into the source plasma by the plasma generator 134. Depending on the application, the process gas 146 can be a neutral gas or gas mixture, or a weakly ionized gas or gas mixture. The process gas 146 may contain fusion reactants. For example, in some embodiments, the process gas 146 may be deuterium gas (D-D reaction), a gas mixture containing deuterium and tritium (D-T reaction), a gas mixture containing deuterium and helium-3 (D-3He reaction), or a gas mixture containing protons and boron (p⁺-¹¹B reaction). Other mixtures may include hydrogen or helium. The source plasma 110 may be formed by supplying the process gas 146 to the plasma formation region 144 and by applying a voltage between the inner and outer electrodes 140, 142 to ionize or otherwise energize the process gas 146 into the source plasma 110. For this purpose, each plasma generator 134 of the plasma formation and injection device 104 can include or be coupled to a process gas supply unit 150 and a plasma formation power supply 152. Depending on the application, the operation of introducing the process gas 146 into the plasma formation region 144 can be initiated before, at the same time as, or after initiating the operation of activating the plasma formation power supply 152 to apply the voltage between the inner electrode 140 and the outer electrode 142.

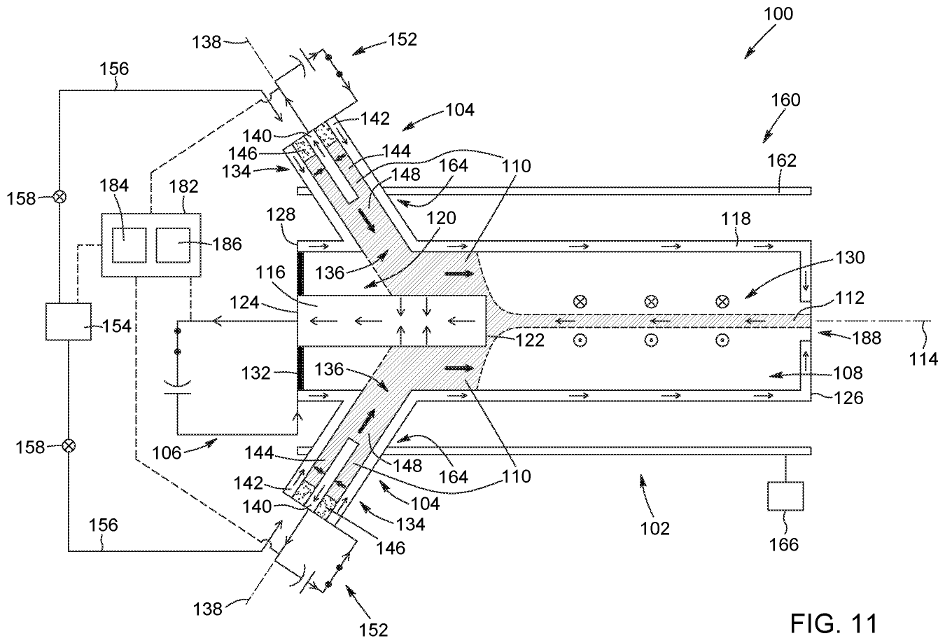

Referring still to FIG. 7, the process gas supply unit 150 is configured to supply the process gas 146 into the plasma formation region 144. The process gas supply unit 150 can include or be coupled to a process gas source 154 configured to store the process gas 146. The process gas source 154 may be embodied by a gas storage tank or any suitable pressurized gas dispensing container. The process gas supply unit 150 may also include a process gas supply line 156 (e.g., including gas conduits or channel) configured to convey the process gas 146 from the process gas source 154 and the plasma formation region 144 of each plasma generator 134. The process gas supply unit 150 may further include a process gas supply valve 158 or other flow control devices configured to control a flow of the process gas 146 along the process gas supply line 156, from the process gas source 154 to the plasma formation region 144 of each plasma generator 134. The process gas supply valve 158 may be embodied by a variety of electrically actuated valves, such as solenoid valves. Other flow control devices (not shown), such as pumps, regulators, and restrictors, may be provided to control the process gas flow rate and pressure along the process gas supply line 156. Various process gas injection configurations may be used depending on the application. For example, referring to FIG. 11, in some embodiments, the process gas supply unit 150 may include a single process gas source 154 configured to supply process gas 146 to multiple plasma generators 134, rather than each plasma generator 134 being connected to its own dedicated process gas source 154, as in FIG. 7. It is noted that the embodiment of FIG. 11 may otherwise share several features with the embodiment of FIG. 7, which need not be described again.

Returning to FIG. 7, the plasma formation and injection device 104 includes a pair of plasma formation power supplies 152, each of which associated with a corresponding one of the plasma generator 134. The plasma formation power supplies 152 are distinct from the main power supply 106 coupled to the inner electrode 116 and the outer electrode 118 of the plasma confinement device 102. Depending on the application, the plasma formation power supplies 152 may or may not be identical to each other. Each plasma formation power supply 152 is connected to the inner electrode 140 and the outer electrode 142 of its corresponding plasma generator 134 via appropriate electrical connections. In the illustrated embodiment, each plasma formation power supply 152 includes a capacitor bank and a switch, although other suitable types of power supplies may be used in other embodiments (e.g., flywheel power supplies). Each plasma formation power supply 152 is configured to apply a voltage between the inner and outer electrodes 140, 142 to generate an ionizing electric field across the plasma formation region 144. The ionizing electric field is configured to ionize and break down the process gas 146, thereby forming into the source plasma 110. In some embodiments, the voltage applied between the inner and outer electrodes 140, 142 may range from about 750 V to about 5 kV, although other voltage values may be used in other embodiments. It is appreciated that the configuration and the operation of the plasma formation power supplies 152 may be adjusted to favor the breakdown of the process gas 146 and control the parameters of the source plasma 110.

It is appreciated that in other embodiments, the plasma formation and injection device 104 may use other types of plasma sources and plasma formation techniques to form the source plasma 110. Non-limiting examples of such possible plasma sources include, to name a few, gas injected washer plasma guns; plasma thrusters, for example, Hall effect thrusters and MHD thrusters; if the source plasma 110 is magnetized, high-power helicon plasma sources; RF plasma sources; plasma torches; and laser-based plasma sources.

Referring still to FIG. 7, the portion of the source plasma 110 formed by each plasma generator 134 is flowed, directed, or otherwise moved along the plasma transport channel 148 from the plasma formation region 144 to the corresponding plasma injector 136 for injection into the acceleration region 120. It is appreciated that the portions of the source plasma 110 formed by the two plasma generators 134 may have the same or different plasma compositions or parameters. Transport of the source plasma 110 along the plasma transport channel 148 can be achieved by or as a result of the axial momentum imparted to the source plasma 110 as it leaves the plasma formation region 144. In particular, the formation of the source plasma 110 can result in a radial electric current and an azimuthal magnetic field. The interaction between the radial electric current and the azimuthal magnetic field produces an axial Lorentz force that pushes and accelerates the source plasma 110 forward along the plasma formation region and into the plasma transport channel 148 toward the plasma injector 136.

In the illustrated embodiment, each plasma injector 136 is provided as a plasma injection port or opening formed through the outer peripheral surface of the outer electrode 118 of the plasma confinement device 102 and establishing a pathway between the plasma transport channel 148 of the corresponding plasma generator 134 and the acceleration region 120 of the plasma confinement device 102. The plasma injectors 136 can be used to control the rate of introduction of the source plasma 110 into the acceleration region 120 and the plasma properties, which in turn can provide better control over the lifetime and other properties of the Z-pinch plasma 112. It is appreciated that the parameters of each plasma injector 136 may be individually adjusted in accordance with the application. For example, in the embodiment of FIG. 7, the two plasma injectors 136 have diametrically opposed azimuthal positions but have otherwise identical parameters. However, in other embodiments, the plasma injectors 136 may differ from one another in other respects. Non-limiting examples of plasma injector parameters include the size, shape, and configuration of the injection port; the axial and/or azimuthal position of the injection port with respect to the Z-pinch axis 114 of the plasma confinement device 102; the plasma injection plane, which is defined as the plane encompassing the Z-pinch axis 114 and the plasma formation axis 138 of the plasma generator 134; and the plasma injection angle, which defined as the angle between the Z-pinch axis 114 and the plasma formation axis 138. For example, in the embodiment of FIG. 7, the flow direction of the source plasma 110 along the plasma transport channel 148 (i.e., along the plasma formation axis 138) makes an acute angle with the flow direction of the source plasma 110 along the acceleration region 120 (i.e., along the Z-pinch axis 114). The provision of an acute angle can be used to provide an axial flow to the source plasma 110 injected in the acceleration region 120, to provide better coupling efficiency with the magnetic field present in the acceleration region 120, and/or to allow the source plasma 100 to gain more azimuthal velocity and to more easily fill the acceleration region 120.

In some embodiments, the plasma processing system 100 may include a vacuum system 160. The vacuum system 160 includes a vacuum chamber 162, for example, a stainless steel pressure vessel. The vacuum chamber 162 is configured to house at least partially various components of the plasma processing system 100, including at least part of the inner electrode 116 and the outer electrode 118 of the plasma confinement device 102. The vacuum chamber 162 may include vacuum ports 164 formed therethrough to allow the source plasma 110 formed by the plasma formation and injection device 104 and to be coupled into the reaction chamber 108 of the plasma confinement device 102. The vacuum system 160 may also include a pressure control system 166 configured to control the operating pressure inside the vacuum chamber 162. In some embodiments, the pressure inside the vacuum chamber 162 may range from about 10⁻⁹ Torr to about 20 Torr, although other ranges of pressure may be used in other embodiments.

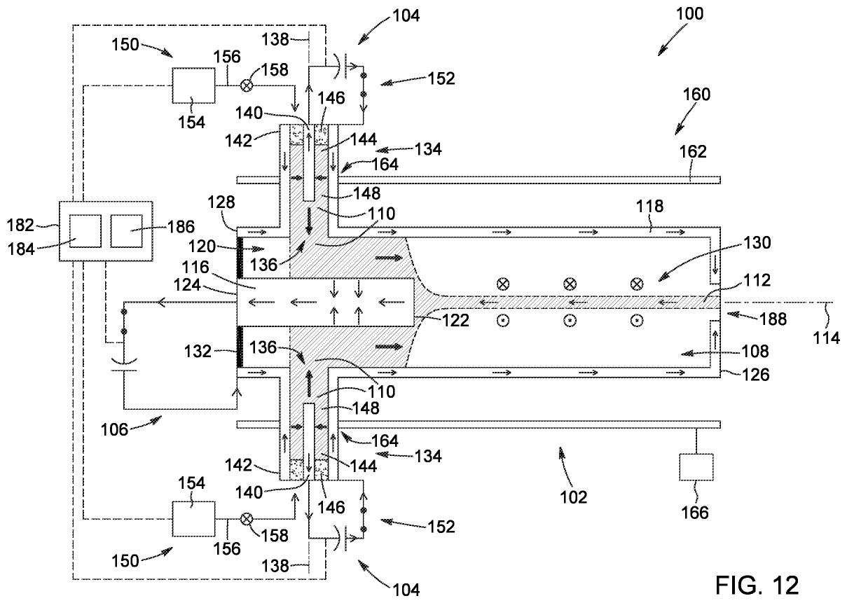

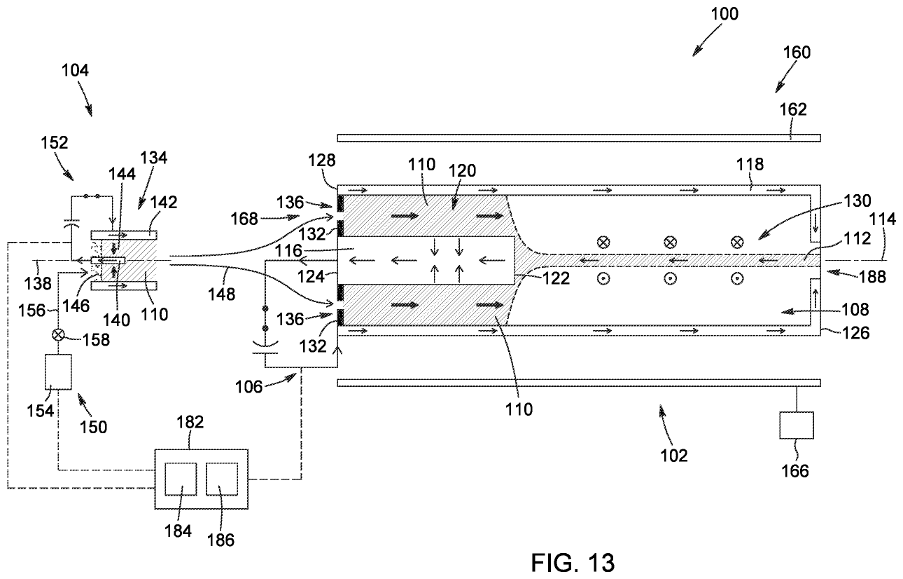

Referring to FIGS. 12 and 13, there are illustrated possible embodiments of a plasma processing system 100 in which the plasma injectors 136 of the plasma formation and injection device 104 have different plasma injection angles (i.e., 90° in FIG. 12 and 0° in FIG. 13, rather than the acute plasma injection angle θ, where 0°<θ<90°, as depicted in FIG. 7) and/or different plasma injection points (i.e., through a rear end wall or portion 168 of the plasma confinement device 102, as in the embodiment of FIG. 13, rather than through the peripheral wall of the outer electrode 118, as in the embodiment of FIG. 7). It is noted that the embodiments of FIGS. 12 and 13 may otherwise share several features with the embodiment of FIG. 7, which need not be described again. It is also noted that the embodiments are provided by way of example only, and various other plasma injection configurations are contemplated by the present techniques.

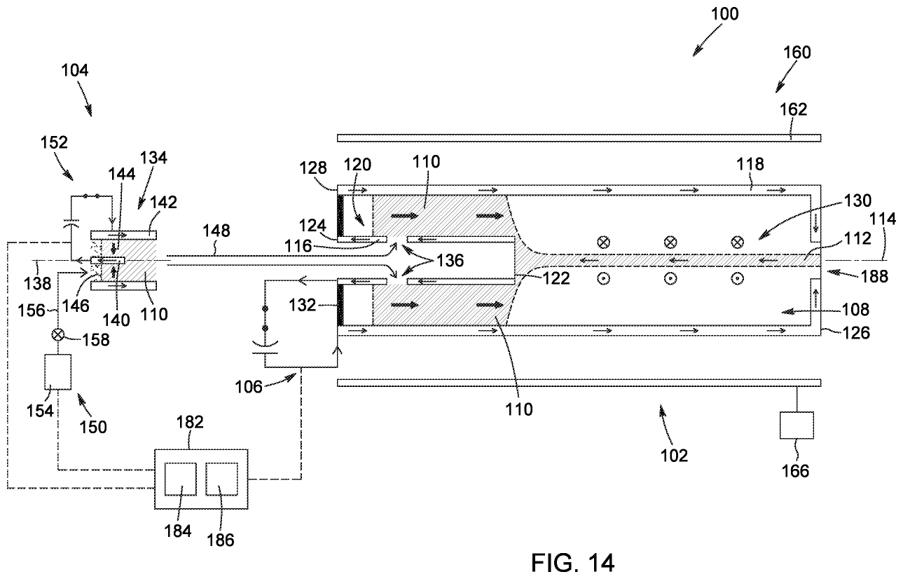

Referring to FIG. 14, there is illustrated another possible embodiment of a plasma processing system 100. The embodiment of FIG. 14 shares several features with the embodiment of FIG. 7, which will not be described again other than to highlight differences between them. In contrast to the embodiment of FIG. 7, where the plasma injectors 136 of the plasma formation and injection device 104 are provided as plasma injection ports formed through the outer electrode 118 of the plasma confinement device 102, in the embodiment of FIG. 14, the plasma injectors 136 are provided as plasma injection ports formed through the inner electrode 116 of the plasma confinement device 102. The inner electrode 116 has a hollow configuration so as to provide a pathway for the plasma transport channel 148 from the plasma formation region to the plasma injector 136. In FIG. 14, the plasma generator 134 is disposed outside the inner electrode 116, but configurations in which the plasma generator 134 is disposed inside the inner electrode 116 are also contemplated, as long as the source plasma 110 is formed outside the reaction chamber 108 of the plasma confinement device 102, and then injected in the reaction chamber 108 to be compressed into the Z-pinch plasma 112.

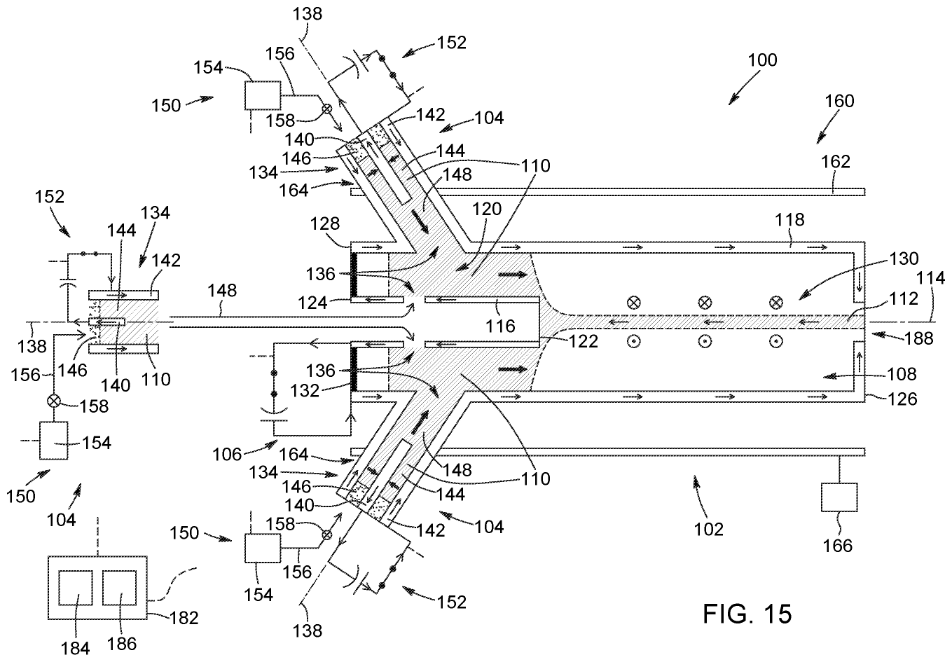

From FIGS. 7 and 14, it is appreciated that depending on the application, the one or more plasma injectors 136 of the plasma formation and injection device 104 may be formed only through the outer electrode 118 (as in FIG. 7), only through the inner electrode 116 (as in FIG. 14), or through both the outer electrode 118 and the inner electrode 116 (as in FIG. 15). It is noted that the embodiment of FIG. 15 shares several features with the embodiment of FIG. 7, which need not be described again. It is also appreciated that the number of plasma injectors 136 of the plasma formation and injection device 104 and their longitudinal, azimuthal, and radial arrangement with respect to the acceleration region 120 of the plasma confinement device 102 can be varied to suit the needs or the preferences of a given application.

Several embodiments described above involves injecting, inside a reaction chamber of a plasma confinement device, a source plasma formed outside the reaction chamber, the injection being carried out to both create and sustain a Z-pinch plasma inside the reaction chamber. However, in other embodiments, the injection of an externally formed source plasma inside a reaction chamber of a plasma confinement device can be carried out to feed and sustain a pre-existing Z-pinch plasma. That is, the injection of the source plasma inside the reaction chamber can be initiated only once a Z-pinch plasma has been formed inside the reaction chamber. The formation of the pre-existing Z-pinch plasma can be performed based on a Z-pinch startup operation involving a step of injecting a startup neutral gas into the reaction chamber, a step of energizing the startup neutral gas into a startup plasma, and a step of compressing the startup plasma into the pre-existing Z-pinch plasma. It is appreciated that, in such embodiments, the Z-pinch startup operation can be based on a conventional, neutral-gas-based approach to forming a Z-pinch plasma, such as the one depicted in FIGS. 1 to 5.

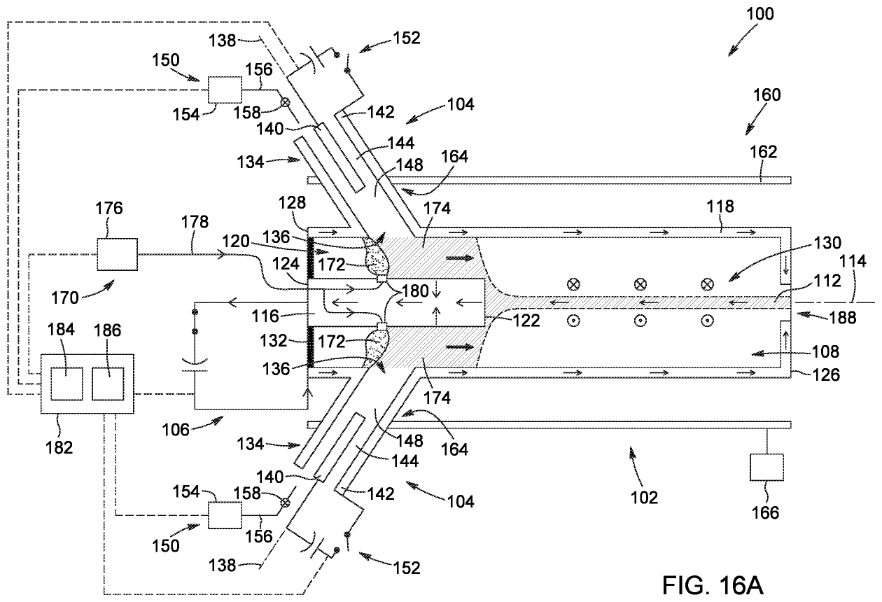

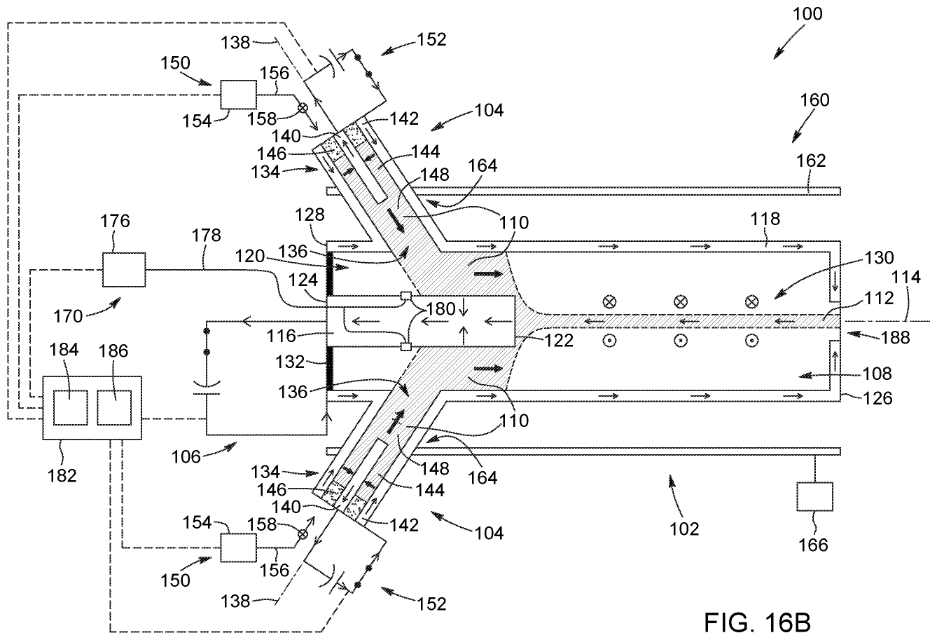

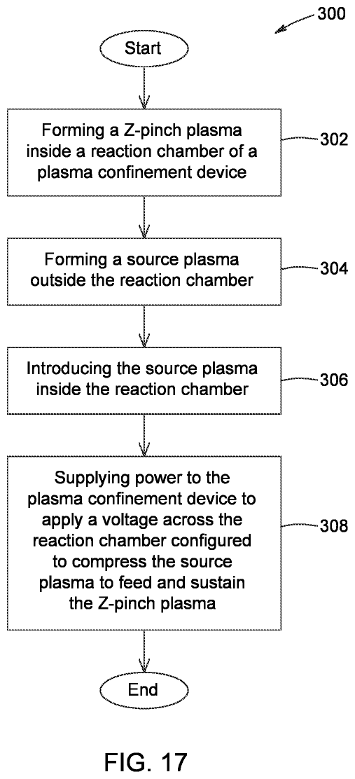

Referring to FIGS. 16A and 16B, there is illustrated another possible embodiment of a plasma processing system 100, whose operation involves two main process phases. Reference is also made to FIG. 17, which is a flow diagram of an embodiment of plasma processing method 300. The method 300 of FIG. 17 may be implemented in a plasma processing system 100 such as the one depicted in FIGS. 16A and 16B, or another suitable plasma processing system. The first process phase includes a step 302 of forming a Z-pinch plasma 112 inside a reaction chamber 108 of a plasma confinement device 102, for example, by supplying a startup neutral gas 172 inside the reaction chamber 108 and energizing and compressing the startup neutral gas 172 into the Z-pinch plasma 112 (see also FIG. 16A). The second process phase includes a step 304 of forming a source plasma 110 outside the reaction chamber 108, a step 306 of introducing the source plasma 110 inside the reaction chamber 108, and a step 308 of supplying power to the plasma confinement device 102 to apply a voltage across the reaction chamber 108 so as to compress the source plasma 110 to feed and sustain the Z-pinch plasma 112 (see also FIG. 16B).

The embodiment of FIGS. 16A and 16B shares several features with the embodiment of FIG. 7, which will not be described again other than to highlight differences between them. The plasma processing system 100 of FIGS. 16A and 16B includes a startup neutral gas supply unit 170 configured to inject a startup neutral gas 172 in the acceleration region 120 of the reaction chamber 108 of the plasma confinement device 102. Upon the application by the main power supply 106 of a startup voltage between the inner electrode 116 and the outer electrode 118, the startup neutral gas 172 injected in the acceleration region 120 can be ionized into a startup plasma 174, accelerated along the acceleration region 120 and into the assembly region 130, and compressed into a Z-pinch plasma 112 along the Z-pinch axis 114 in the assembly region 130 (FIG. 16A).

The startup neutral gas 172 can be any suitable gas or gas mixture capable of being energized into a startup plasma 174 upon being injected into the acceleration region 120 and energized by the main power supply 106. The startup neutral gas 172 may contain fusion reactants. For example, in some embodiments, the startup neutral gas 172 may be deuterium gas or a gas mixture containing deuterium and tritium. Other gas mixtures for the startup neutral gas 172 may include hydrogen or helium. Depending on the application, the composition and properties of the startup neutral gas 172 supplied by the startup neutral gas supply unit 170 may or may not be the same as the composition and corresponding properties of the process gas 146 from which the source plasma 110 is formed by the plasma formation and injection device 104. In some embodiments, the startup neutral gas supply unit 170 and the process gas supply unit 150 can be embodied by the same gas supply unit.

Referring still to FIGS. 16A and 16B, the startup neutral gas supply unit 170 can include or be coupled to a startup neutral gas source 176 configured to store the startup neutral gas 172. The startup neutral gas source 176 may be embodied by a gas storage tank or any suitable pressurized gas dispensing container. The startup neutral gas supply unit 170 may also include a startup neutral gas supply line 178 configured to convey the startup neutral gas 172 from startup neutral gas source 176 to the acceleration region 120. The startup neutral gas supply unit 170 may further include various flow control devices (not shown), such as valves, pumps, regulators, and restrictors, to control a flow of the startup neutral gas 172 along the startup neutral gas supply line 178, from the startup neutral gas source 176 to the acceleration region 120.

To allow injection of the startup neutral gas 172 into the acceleration region 120, the plasma confinement device 102 includes startup neutral gas injection ports 180 connected to the startup neutral gas supply line 178 and leading into the acceleration region 120. In the illustrated embodiment, the plasma confinement device 102 includes two startup neutral gas injection ports 180 formed through the inner electrode 116 at opposite azimuthal positions. Depending on the application, the startup neutral gas injection ports 180 may be formed only through the inner electrode 116, only through the outer electrode 118, through both the inner electrode 116 and the outer electrode 118, or at any other suitable locations of the plasma confinement device 102. The gas injection configuration and the number and arrangement of the startup neutral gas injection ports 180 can be varied to suit the needs of a particular application.

Referring more specifically to FIG. 16B, once the Z-pinch plasma 112 has been established by injection, ionization, acceleration and compression of the startup neutral gas 172, corresponding to the first process phase, the operation of the plasma processing system 100 can proceed to the second process phase. The second process phase can proceed as described above with respect to FIG. 7, except that the Z-pinch plasma 112 is already formed or being formed when the injection of the source plasma 110 in the reaction chamber 108 is initiated. During the second process phase, the injection of the startup neutral gas 172 is stopped and the injection of the source plasma 110 is initiated. Depending on the application, the injection of the startup neutral gas 172 can be stopped before, at the same time as, or after the injection of the source plasma 110 is initiated. The purpose of the second process phase is to use the source plasma 110 as fuel to feed and sustain the Z-pinch plasma 112 that was initiated by neutral gas startup during the first process phase. It is appreciated that using plasma injection rather than neutral gas injection to sustain a Z-pinch plasma 112 after its formation by neutral gas startup can provide enhanced control over the Z-pinch stability and properties.

Returning to FIG. 7, it is appreciated that the injection of the source plasma 110 into the acceleration region 120 of the reaction chamber 108 of the plasma confinement device 102 can be a complex and delicate process. The process can involve, inter alia, the coupling of the source plasma 110 with the magnetic field present in the acceleration region 120, which is created by the application of the voltage between the inner electrode 116 and the outer electrode 118 of the plasma confinement device 102. Being electrically conducting, the source plasma 110 tends to oppose the change of magnetic flux therethrough caused by its motion relative to the magnetic field present in the acceleration region 120. This, in turn, can impede or otherwise affect the motion of the source plasma 110 as its enters the acceleration region 120. In some embodiments, the process of injecting and coupling the source plasma 110 into the acceleration region 120 may be described using an MHD formulation able to model the properties and behavior of electrically conducting fluids in the presence of magnetic fields. Depending on the application, different approaches may be implemented to facilitate or achieve better control over the injection of the source plasma 110 inside the acceleration region 120.

In some embodiments, the electrical resistivity of the source plasma 110 may be increased as a way to decrease its tendency to oppose changes in magnetic flux and, in turn, its tendency to oppose its motion in the magnetic field present in the acceleration region 120. The resistivity of the source plasma 110 may be increased by decreasing its temperature, which itself may be achieved by reducing the energy put into the process gas 146 used to generate the source plasma 110.

In some embodiments, the source plasma 110 may be generated as an unmagnetized plasma. It is appreciated that using an unmagnetized plasma as the source plasma 110 may be favored in the certain applications. One reason stems from the fact that the interaction between the magnetic field of the source plasma 110 and the magnetic field present in the acceleration region 120 may then be avoided. However, in other applications, using a magnetized plasma as the source plasma 110 may be useful, for example, in a case where the magnetic field of the magnetized source plasma 110 is parallel to the magnetic field in the acceleration region 120 and adjusted to provide a desired magnetic flux profile at the injection point.

In some embodiments, the injection of the source plasma 110 may be controlled by adjusting the relative orientation between the velocity of the source plasma 110 injected into the acceleration region 120 and the magnetic field present in the acceleration region 120. Various injection schemes are contemplated. For example, the velocity of the source plasma 110 may be strictly axial (see, e.g., FIG. 13), strictly radial (see, e.g., FIG. 12), or it may have both a radial and an axial component (see, e.g., FIGS. 7, 8, 10, and 11). In the embodiments depicted in FIGS. 7 to 15, the velocity of the source plasma 110 is generally perpendicular to the magnetic field present the acceleration region 120. However, in other embodiments, the velocity of the source plasma 110 may have an azimuthal component or be strictly azimuthal.

Returning to FIG. 7, the plasma processing system 100 can further include a control and processing device 182, which is configured to control, monitor, and coordinate the functions and operation of various components of the plasma processing system 100, as well as various temperature, pressure, and power conditions. Non-limiting examples of components that can be controlled by the control and processing device 182 include the main power supply 106, the process gas supply unit 150, and the plasma formation power supply 152. For example, the control and processing device 182 may be configured to control the operation of the process gas supply unit 150 to supply the process gas 146 in the plasma formation region 144 of each plasma generator 134 of the plasma formation and injection device 104; to control the operation of the plasma formation power supply 152 to supply power to each plasma generator 134 to energize the process gas 146 into the source plasma 110; and to control the operation of the main power supply 106 to apply a voltage between the inner electrode 116 and the outer electrode 118 of the plasma confinement device 102 to cause the source plasma 110 to flow along the acceleration region 120 and into the assembly region 130 and to be compressed into the Z-pinch plasma 112 in the assembly region 130. In particular, the control and processing device 182 may be configured to synchronize or otherwise time-coordinate the functions and operation of various components of the plasma processing system 100.

The control and processing device 182 may be implemented in hardware, software, firmware, or any combination thereof, and be connected to various components of the plasma processing system 100 via wired and/or wireless communication links configured to send and/or receive various types of signals, such as timing and control signals, measurement signals, and data signals. The control and processing device 182 may be controlled by direct user input and/or by programmed instructions, and may include an operating system for controlling and managing various functions of the plasma processing system 100. Depending on the application, the control and processing device 182 may be fully or partly integrated with, or physically separate from, the other hardware components of the plasma processing system 100. The control and processing device 182 can include a processor 184 and a memory 186.

The processor 184 may be able to execute computer programs, also generally known as commands, instructions, functions, processes, software codes, executables, applications, and the like. It should be noted that although the processor 184 in FIG. 7 is depicted as a single entity for illustrative purposes, the term “processor” should not be construed as being limited to a single processor, and accordingly, any known processor architecture may be used. In some implementations, the processor 184 may include a plurality of processing units. Such processing units may be physically located within the same device, or the processor 184 may represent processing functionality of a plurality of devices operating in coordination. For example, the processor 184 may include or be part of a computer; a microprocessor; a microcontroller; a coprocessor; a central processing unit (CPU); an image signal processor (ISP); a digital signal processor (DSP) running on a system on a chip (SoC); a single-board computer (SBC); a dedicated graphics processing unit (GPU); a special-purpose programmable logic device embodied in hardware device, such as, for example, a field-programmable gate array (FPGA) or an application-specific integrated circuit (ASIC); a digital processor; an analog processor; a digital circuit designed to process information; an analog circuit designed to process information; a state machine; and/or other mechanisms configured to electronically process information and to operate collectively as a processor.

The memory 186, which may also be referred to as a “computer readable storage medium” is capable of storing computer programs and other data to be retrieved by the processor 184. In the present description, the terms “computer readable storage medium” and “computer readable memory” are intended to refer to a non-transitory and tangible computer product that can store and communicate executable instructions for the implementation of various steps of the methods disclosed herein. The computer readable memory may be any computer data storage device or assembly of such devices, including a random-access memory (RAM); a dynamic RAM; a read-only memory (ROM); a magnetic storage device, such as a hard disk drive, a solid state drive, a floppy disk, and a magnetic tape; an optical storage device, such as a compact disc (CD or CDROM), a digital video disc (DVD), and a Blu-Ray™ disc; a flash drive memory; and/or any other non-transitory memory technologies. A plurality of such storage devices may be provided. The computer readable memory may be associated with, coupled to, or included in a computer or processor configured to execute instructions contained in a computer program stored in the computer readable memory and relating to various functions associated with the computer.

The plasma processing system 100 may also include one or more user interface devices (not shown) operatively connected to the control and processing device 182 to allow the input of commands and queries to the plasma processing system 100, as well as present the outcomes of the commands and queries. The user interface devices may include input devices (e.g., a touch screen, a keypad, a keyboard, a mouse, a switch, and the like) and output devices (e.g., a display screen, a printer, visual and audible indicators and alerts, and the like).

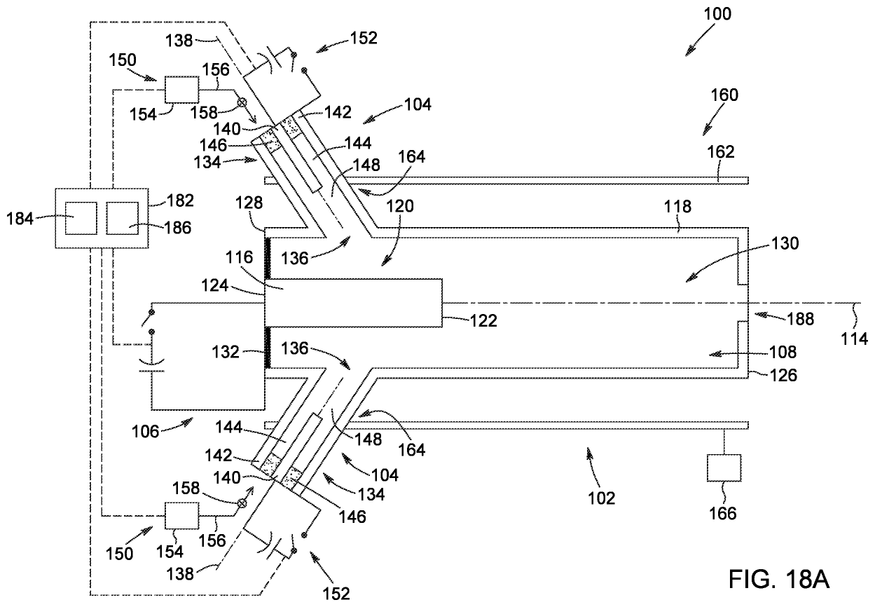

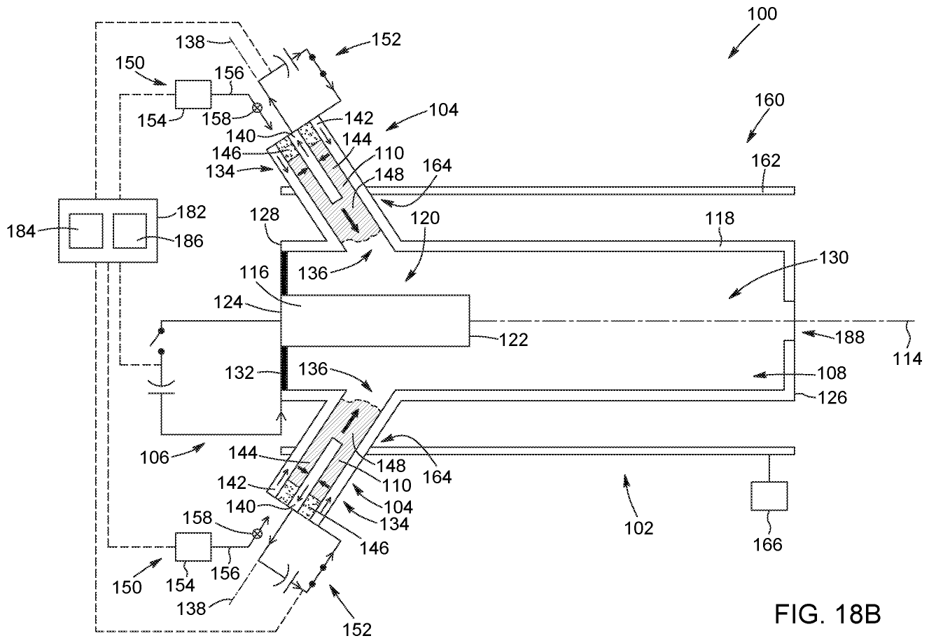

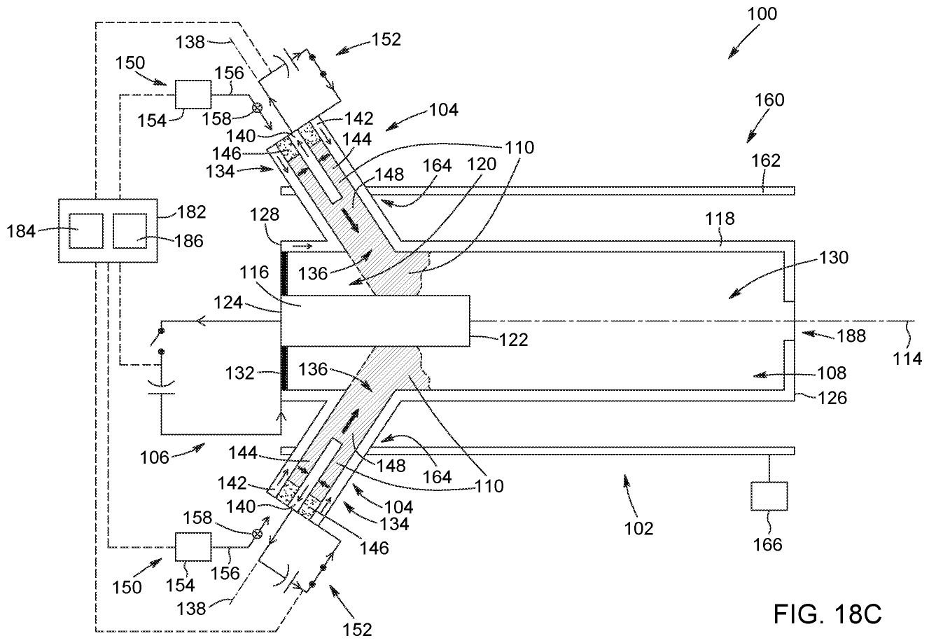

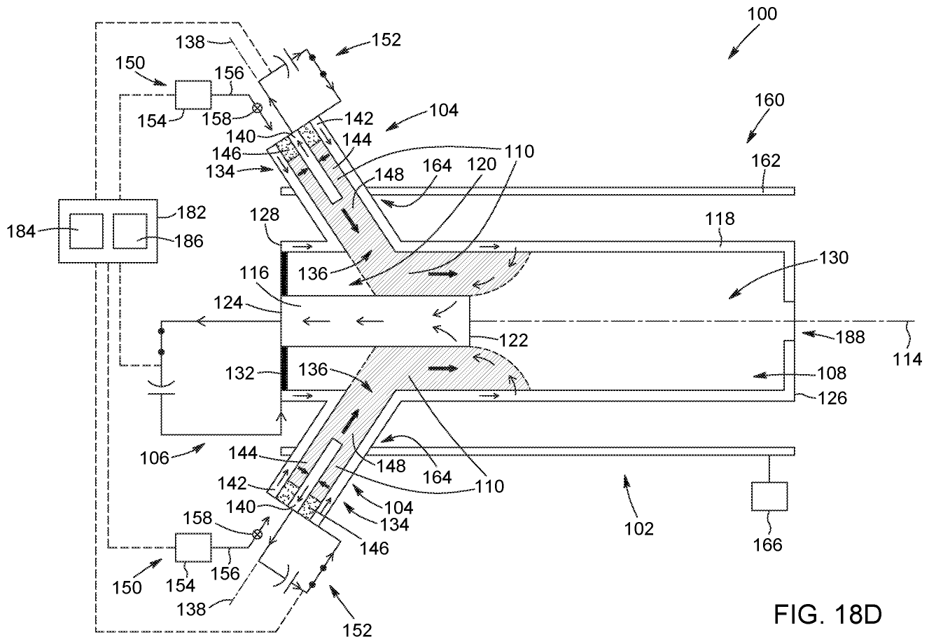

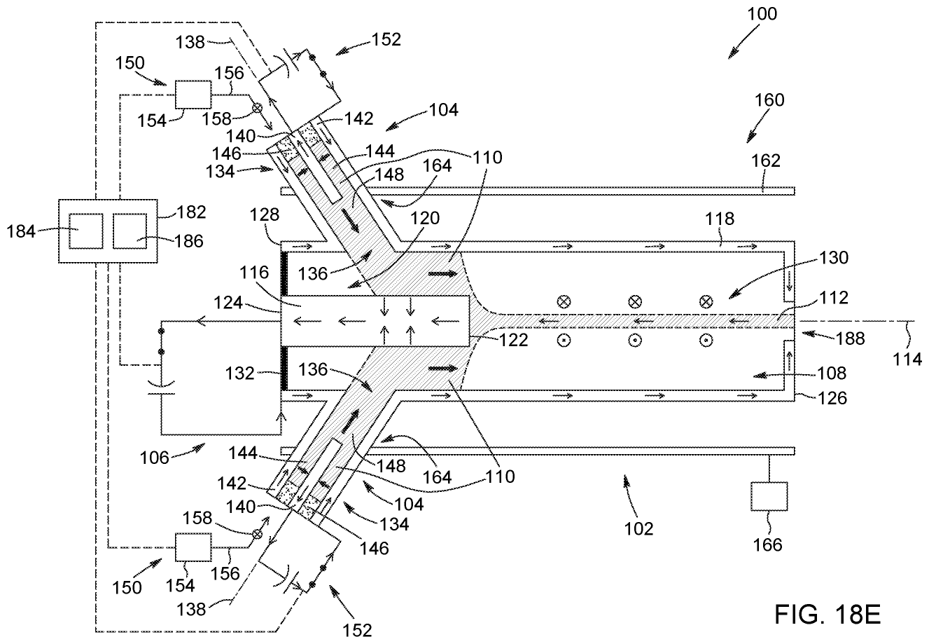

Referring to FIGS. 18A to 18E, a method of operating a plasma processing system 100 to generate a Z-pinch plasma 112 will be described in greater detail. The plasma processing system 100 illustrated in FIGS. 18A to 18E correspond to that illustrated in the embodiment of FIG. 7, depicted at different stages of its operation. The plasma processing system 100 of FIGS. 18A to 18E generally includes a plasma confinement device 102, a plasma formation and injection device 104, a main power supply 106, and a control and processing device 186. The plasma confinement device 102 includes an inner electrode 116, an outer electrode 118, and a reaction chamber 108 defining an acceleration region 120 and an assembly region 130. The plasma formation and injection device 104 is coupled to, but disposed externally of, the reaction chamber 108 of the plasma confinement device 102. The plasma formation and injection device 104 is configured to generate an source plasma 110 outside the acceleration region 120 and to inject the source plasma 110 into the acceleration region 120. The main power supply 106 is configured to supply electric power to the plasma confinement device 102 to apply a voltage between the inner electrode 116 and the outer electrode 118. The control and processing unit 182 is configured to control and time-coordinate the functions and operation of the other components of the plasma processing system 100.

The method can include a step of forming the source plasma 110 outside the acceleration reaction chamber 108 of the plasma confinement device 102. The formation of the source plasma 110 can include a step of using a process gas supply unit 150 to introduce process gas 146 into the plasma formation region 144 of each plasma generator 134 of the plasma formation and injection device 104, as depicted in FIG. 18A. The formation of the source plasma 110 can also include a step using a plasma formation power supply 152 to apply a voltage between the inner electrode 140 and the outer electrode 142 of each plasma generator 134 to energize the process gas 146 into the source plasma 110, as depicted in FIG. 18B. Once formed, the source plasma 110 is accelerated along the plasma formation region 144 and the plasma transport channel 148 toward the corresponding plasma injector 136. In the steps of the method illustrated in FIGS. 18A and 18B, the operation of introducing the process gas 146 into the plasma formation region 144 is initiated before initiating the operation of activating the plasma formation power supply 152 to apply the voltage between the inner electrode 140 and the outer electrode 142 of each plasma generator 134. For example, in some embodiments, the time delay between initiating the introduction of the process gas 146 into the plasma formation region 144 and initiating the activation of the plasma formation power supply 152 can range between about 500 its and 3 ms. However, in other embodiments, the operation of introducing the process gas 146 into the plasma formation region 144 can be initiated at the same time as or after initiating the operation of activating the plasma formation power supply 152.

Referring to FIG. 18C, the method of operating the plasma processing system 100 can include a step of introducing the source plasma 110 inside the reaction chamber 108 of the plasma confinement device 102. In FIG. 18C, the introduction of the source plasma 110 inside the reaction chamber 108 includes a step of injecting the source plasma 110 into the acceleration region 120 of the reaction chamber 108.

Referring to FIGS. 18D and 18E, the method of operating the plasma processing system 100 can include a step of using the main power supply 106 to supply power to the plasma confinement device 102 to apply a voltage between the inner electrode 116 and the outer electrode 118 of the plasma confinement device 102. The voltage is configured to cause the source plasma 110 to flow along the acceleration region 120 and into the assembly region 130 (FIG. 18D) and to be compressed into the Z-pinch plasma 112 in the assembly region 130 (FIG. 18E). In the steps of the method illustrated in FIGS. 18C to 18D, the operation of introducing the source plasma 110 into the acceleration region 120 is initiated before initiating the operation of activating the main power supply 106 to apply the voltage between the inner electrode 116 and the outer electrode 118 of the plasma confinement device 102. For example, in some embodiments, the time delay between initiating the introduction of the source plasma 110 into the acceleration region 120 and initiating the activation of the main power supply 106 can range from about 0 μs and about 200 its. However, in other embodiments, the operation of introducing the source plasma 110 into the acceleration region 120 can be initiated at the same time as or after initiating the operation of activating the main power supply 106.

In some embodiments, the Z-pinch plasma 112 may have the following properties and parameters: a plasma radius ranging from about 0.1 mm to about 5 mm, a magnetic field ranging from about 1 T to about 8 T, an electron temperature ranging from about 500 eV to about 10 keV, an ion temperature ranging from about 500 eV to about 10 keV, an electron density ranging from about 10¹⁶ cm⁻³ to about 10²⁰ cm⁻³, an ion density ranging from about 10¹⁶ cm⁻³ to about 10²⁰ cm⁻³, and a stable lifetime exceeding 10 its (e.g., up to 1 ms). These values are provided by way of example, so that other values may be used in other embodiments. Depending on the application, the Z-pinch plasma 112 may or may not be sheared-flow stabilized.

Referring to FIG. 18E, in some embodiments, the operation of the plasma processing system 100 can include continuing or maintaining the steps of introducing the source plasma 110 inside the acceleration region 120 and supplying power to the plasma confinement device 102 to sustain the Z-pinch plasma 112 after the Z-pinch plasma 112 has been formed in the assembly region 130.

In some embodiments, the plasma processing system 100 may be configured to compress the Z-pinch plasma 112 sufficiently to reach fusion conditions, whereby particles inside the Z-pinch plasma 112 undergo nuclear fusion reactions. In some embodiments, the nuclear fusion reactions produced and sustained inside the Z-pinch plasma 112 can include neutronic fusion reactions, that is, nuclear reactions that produce neutrons. In some of these embodiments, the energy of the neutrons thus provided can be converted into electricity in fusion power applications.

Numerous modifications could be made to the embodiments described above without departing from the scope of the appended claims.

1. A plasma processing system, comprising:
a plasma confinement device comprising a reaction chamber;
a plasma formation and injection device configured to form a source plasma outside the reaction chamber and inject the source plasma inside the reaction chamber; and
a main power supply configured to supply power to the plasma confinement device to apply a voltage across the reaction chamber configured to compress the source plasma into a Z-pinch plasma.

2. The plasma processing system of claim 1, wherein:
the plasma confinement device comprises:
an inner electrode; and
an outer electrode surrounding the inner electrode to define an acceleration region therebetween, the outer electrode extending beyond the inner electrode along a Z-pinch axis to define an assembly region adjacent the acceleration region, the acceleration region and the assembly region forming the reaction chamber;
the plasma formation and injection device is configured to inject the source plasma into the acceleration region; and
the main power supply is configured to apply the voltage between the inner electrode and the outer electrode to cause the source plasma to flow along the acceleration region and into the assembly region and to be compressed into the Z-pinch plasma along the Z-pinch axis in the assembly region.

3. The plasma processing system of claim 2, wherein the outer electrode surrounds the inner electrode coaxially with respect to the Z-pinch axis.

4. The plasma processing system of claim 2 or 3, wherein the inner electrode and the outer electrode each have a circular cross-section transverse to the Z-pinch axis.

5. The plasma processing system of any one of claims 2 to 4, wherein the acceleration region has a length ranging from about 25 cm to about 1.5 m, and wherein the assembly region has a length ranging from about 25 cm to about 3 m.

6. The plasma processing system of any one of claims 2 to 5, wherein the plasma formation and injection device comprises:
a plasma generator configured to generate the source plasma; and
a plasma injector configured to inject the source plasma into the acceleration region.

7. The plasma processing system of claim 6, wherein the plasma injector comprises a plasma injection port formed through the inner electrode, through the outer electrode, or through a rear end wall of the plasma confinement device.

8. The plasma processing system of claim 6 or 7, wherein the plasma generator comprises a plurality of plasma generators, each plasma generator being configured to generate a respective portion of the source plasma, and wherein the plasma injector comprises a plurality of plasma injectors, each plasma injector corresponding to a respective one of the plasma generators and being configured to inject the respective portion of the source plasma into the acceleration region.

9. The plasma processing system of any one of claims 6 to 8, wherein the plasma generator comprises:
an inner electrode; and
an outer electrode surrounding the inner electrode to define a plasma formation region therebetween, the outer electrode extending beyond the inner electrode along a plasma formation axis to enclose a plasma transport channel extending from the plasma formation region to the plasma injector along the plasma formation axis.

10. The plasma processing system of claim 9, wherein the plasma formation and injection device comprises:
a process gas supply unit configured to supply a process gas into the plasma formation region; and
a plasma formation power supply configured to apply a voltage between the inner electrode and the outer electrode of the plasma generator to energize the process gas into the source plasma and cause the source plasma to flow along the plasma formation region and through the plasma transport channel to reach the plasma injector for injection of the source plasma into the acceleration region.

11. The plasma processing system of claim 10, wherein the process gas comprises deuterium, tritium, hydrogen, or helium, or any combination thereof.

12. The plasma processing system of claim 10 or 11, wherein the source plasma is configured to flow along a first flow direction in the plasma transport channel and along a second flow direction in the acceleration region, the first flow direction and the second flow direction making an acute angle with respect to each other.

13. The plasma processing system of any one of claims 1 to 12, wherein the plasma formation and injection device is configured to start injecting the source plasma inside the reaction chamber before the main power supply is configured to start applying the voltage across the reaction chamber.

14. The plasma processing system of any one of claims 1 to 12, wherein the plasma formation and injection device is configured to start injecting the source plasma inside the reaction chamber at the same time as or after the main power supply is configured to start applying the voltage across the reaction chamber.

15. The plasma processing system of any one of claims 1 to 14, wherein the plasma formation and injection device is configured to continue injecting the source plasma inside the reaction chamber and the main power supply is configured to continue applying the voltage across the reaction chamber to feed and sustain the Z-pinch plasma.

16. The plasma processing system of any one of claims 1 to 15, wherein the main power supply is a pulsed-DC power supply comprising a capacitor bank and a switch.

17. The plasma processing system of any one of claims 1 to 16, wherein the main power supply is configured to apply the voltage in a voltage range from about 1 kV to about 40 kV.

18. The plasma processing system of any one of claims 1 to 17, wherein the Z-pinch plasma comprises a sheared axial flow.

19. The plasma processing system of any one of claims 1 to 18, wherein the Z-pinch plasma is configured to undergo nuclear fusion reactions in response to compression of the Z-pinch plasma.

20. The plasma processing system of claim 19, wherein the nuclear fusion reactions comprise neutronic fusion reactions.

21. A plasma processing method, comprising:
forming a source plasma outside a reaction chamber of a plasma confinement device;
introducing the source plasma inside the reaction chamber; and
supplying power to the plasma confinement device to apply a voltage across the reaction chamber configured to compress the source plasma into a Z-pinch plasma.

22. The plasma processing method of claim 21, wherein:
introducing the source plasma inside the reaction chamber comprises injecting the source plasma into an acceleration region defined between an inner electrode and an outer electrode of the plasma confinement device, the outer electrode surrounding the inner electrode and extending beyond the inner electrode along a Z-pinch axis to define an assembly region adjacent the acceleration region, the acceleration region and the assembly region forming the reaction chamber; and
supplying power to the plasma confinement device comprises applying the voltage between the inner electrode and the outer electrode to cause the source plasma to flow along the acceleration region and into the assembly region and to be compressed into the Z-pinch plasma along the Z-pinch axis in the assembly region.

23. The plasma processing method of claim 22, wherein injecting the source plasma into the acceleration region comprises injecting the source plasma at least in part from within the inner electrode through at least one plasma injector formed through the inner electrode and leading into the acceleration region.

24. The plasma processing method of claim 22 or 23, wherein injecting the source plasma into the acceleration region comprises injecting the source plasma at least in part from outside the outer electrode through at least one plasma injector formed through the outer electrode and leading into the acceleration region.

25. The plasma processing method of any one of claims 22 to 24, wherein injecting the source plasma into the acceleration region comprises injecting the source plasma at least in part from outside the plasma confinement device through at least one plasma injector formed through a rear end wall of the plasma confinement device and leading into the acceleration region.

26. The plasma processing method of any one of claims 21 to 25, wherein:
forming the source plasma comprises:
supplying a process gas into a plasma formation region of a plasma generator; and
supplying power to the plasma generator to apply a voltage across the plasma formation region configured to energize the process gas into the source plasma; and
introducing the source plasma inside the reaction chamber comprises flowing the source plasma along a plasma transport channel extending between the plasma formation region and the reaction chamber.

27. The plasma processing method of claim 26, wherein the step of supplying the process gas into the plasma formation region is initiated before the step of supplying power to the plasma generator is initiated.

28. The plasma processing method of claim 26, wherein the step of supplying the process gas into the plasma formation region is initiated at the same time as or after the step of supplying power to the plasma generator is initiated.

29. The plasma processing method of any one of claims 26 to 28, wherein the plasma generator comprises:
an inner electrode; and
an outer electrode surrounding the inner electrode to define the plasma formation region therebetween, the outer electrode extending beyond the inner electrode to enclose the plasma transport channel.

30. The plasma processing method of any one of claims 26 to 29, wherein the process gas comprises deuterium, tritium, hydrogen, or helium, or any combination thereof.

31. The plasma processing method of any one of claims 26 to 30, wherein the source plasma is configured to flow in the plasma transport channel along a first flow direction and to flow along a second flow direction after injection inside the reaction chamber, the first flow direction and the second flow direction making an acute angle with respect to each other.

32. The plasma processing method of any one of claims 21 to 31, wherein the step of introducing the source plasma inside the reaction chamber is initiated before the step of supplying power to the plasma confinement device is initiated.

33. The plasma processing method of any one of claims 21 to 31, wherein the step of introducing the source plasma inside the reaction chamber is initiated at the same time as or after the step of supplying power to the plasma confinement device is initiated.

34. The plasma processing method of any one of claims 21 to 33, further comprising continuing the steps of introducing the source plasma inside the reaction chamber and supplying power to the plasma confinement device to feed and sustain the Z-pinch plasma after the Z-pinch plasma has been formed.

35. The plasma processing method of any one of claims 21 to 34, wherein supplying power to the plasma confinement device comprises applying the voltage across the reaction chamber in a voltage range from about 1 kV to about 40 kV.

36. The plasma processing method of any one of claims 21 to 35, further comprising maintaining stability of the Z-pinch plasma.

37. The plasma processing method of claim 36, wherein maintaining stability of the Z-pinch plasma comprises embedding a sheared axial flow inside the Z-pinch plasma.

38. The plasma processing method of any one of claims 21 to 37, further comprising generating nuclear fusion reactions inside the Z-pinch plasma in response to compression of the Z-pinch plasma.

39. The plasma processing method of claim 38, wherein the nuclear fusion reactions comprise neutronic fusion reactions.

40. A plasma processing system, comprising:
a plasma confinement device comprising a reaction chamber configured to generate therein a Z-pinch plasma along a Z-pinch axis;
a plasma formation and injection device configured to form a source plasma outside the reaction chamber and inject the source plasma inside the reaction chamber in the presence of the Z-pinch plasma; and
a main power supply configured to supply power to the plasma confinement device to apply a voltage across the reaction chamber configured to compress the source plasma to sustain the Z-pinch plasma along the Z-pinch axis.

41. The plasma processing system of claim 40, wherein:
the plasma confinement device comprises:
an inner electrode; and
an outer electrode surrounding the inner electrode to define an acceleration region therebetween, the outer electrode extending beyond the inner electrode along the Z-pinch axis to define an assembly region adjacent the acceleration region, the acceleration region and the assembly region forming the reaction chamber;
the plasma formation and injection device is configured to inject the source plasma into the acceleration region; and
the main power supply is configured to apply the voltage between the inner electrode and the outer electrode to cause the source plasma to flow along the acceleration region and into the assembly region to be compressed to feed and sustain the Z-pinch plasma along the Z-pinch axis.

42. The plasma processing system of claim 41, further comprising:
a startup neutral gas supply unit configured to supply a startup neutral gas into the acceleration region,
wherein the main power supply is configured to apply a startup voltage between the inner electrode and the outer electrode to energize the startup neutral gas into a startup plasma and cause the startup plasma to flow along the acceleration region and into the assembly region and to be compressed into the Z-pinch plasma.

43. The plasma processing system of claim 41 or 42, wherein the plasma formation and injection device comprises:
a plasma generator configured to generate the source plasma; and
a plasma injector configured to inject the source plasma into the acceleration region.

44. The plasma processing system of claim 43, wherein the plasma injector comprises a plasma injection port formed through the inner electrode, through the outer electrode, or through a rear end wall of the plasma confinement device.

45. The plasma processing system of claim 43 or 44, wherein the plasma generator comprises:
an inner electrode; and
an outer electrode surrounding the inner electrode to define a plasma formation region therebetween, the outer electrode extending beyond the inner electrode along a plasma formation axis to enclose a plasma transport channel extending from the plasma formation region to the plasma injector along the plasma formation axis.

46. The plasma processing system of claim 45, wherein the plasma formation and injection device comprises:
a process gas supply unit configured to supply a process gas into the plasma formation region; and
a plasma formation power supply configured to apply a voltage between the inner electrode and the outer electrode of the plasma generator to energize the process gas into the source plasma and cause the source plasma to flow along the plasma formation region and through the plasma transport channel to reach the plasma injector for injection of the source plasma into the acceleration region.

47. A plasma processing method, comprising:
forming a Z-pinch plasma inside a reaction chamber of a plasma confinement device;
forming a source plasma outside the reaction chamber;
introducing the source plasma inside the reaction chamber; and
supplying power to the plasma confinement device to apply a voltage across the reaction chamber configured to compress the source plasma to feed and sustain the Z-pinch plasma.

48. The plasma processing method of claim 47, wherein forming the Z-pinch plasma comprises:
supplying a startup neutral gas inside the reaction chamber; and
energizing and compressing the startup neutral gas into the Z-pinch plasma.

49. The plasma processing method of claim 48, further comprising stopping the step of supplying the startup neutral gas inside the reaction chamber once the Z-pinch plasma has been formed and the step of introducing the source plasma inside the reaction chamber has been initiated.

50. The plasma processing method of any one of claims 47 to 49, wherein:
introducing the source plasma inside the reaction chamber comprises injecting the source plasma into an acceleration region defined between an inner electrode and an outer electrode of the plasma confinement device, the outer electrode surrounding the inner electrode and extending beyond the inner electrode along a Z-pinch axis to define an assembly region adjacent the acceleration region, the acceleration region and the assembly region forming the reaction chamber; and
supplying power to the plasma confinement device comprises applying the voltage between the inner electrode and the outer electrode to cause the source plasma to flow along the acceleration region and into the assembly region to be compressed to feed and sustain the Z-pinch plasma along the Z-pinch axis.

51. The plasma processing method of any one of claims 47 to 50, wherein:
forming the source plasma comprises:
supplying a process gas into a plasma formation region of a plasma generator; and
supplying power to the plasma generator to apply a voltage across the plasma formation region configured to energize the process gas into the source plasma; and
introducing the source plasma inside the reaction chamber comprises flowing the source plasma along a plasma transport channel extending between the plasma formation region and the reaction chamber.

52. The plasma processing method of any one of claims 47 to 51, wherein the plasma generator comprises:
an inner electrode; and
an outer electrode surrounding the inner electrode to define the plasma formation region therebetween, the outer electrode extending beyond the inner electrode to enclose the plasma transport channel.

53. The plasma processing method of claim 52, further comprising maintaining stability of the Z-pinch plasma by embedding a sheared axial flow inside the Z-pinch plasma.

54. The plasma processing method of any one of claims 49 to 53, further comprising generating nuclear fusion reactions inside the Z-pinch plasma in response to compression of the Z-pinch plasma.

55. The plasma processing method of claim 54, wherein the nuclear fusion reactions comprise neutronic fusion reactions.
